(19) United States
(12) Patent Application Publication
(10) Pub. No.: US 2018/0056800 A1
(43) Pub. Date: Mar. 1, 2018

(54) RELATIVE POSITION DETERMINATION AND VEHICLE GUIDANCE IN WIRELESS POWER TRANSFER SYSTEMS

(71) Applicant: WiTricity Corporation, Watertown, MA (US)

(72) Inventor: David Paul Meichle, Somerville, MA (US)

(21) Appl. No.: 15/663,412

(22) Filed: Jul. 28, 2017

Related U.S. Application Data
(60) Provisional application No. 62/367,985, filed on Jul. 28, 2016.
(60) Provisional application No. 62/438,103, filed on Dec. 22, 2016.

(51) Int. Cl. B60L 11/18

(52) U.S. Cl. CPC B60L 11/1833; B60L 11/1829; B60L 2230/16; B60L 2240/547; B60L 11/1846

(57) ABSTRACT

The disclosure features systems and methods that include generating a set of Nₘ voltage values using one or more magnetic field detectors, where each voltage value is related in magnitude to an amplitude of a magnetic field between a wireless power source and a wireless power receiver mounted to a vehicle, classifying the set of Nₘ voltage values into one of two classes, where each of the two classes represents a different spatial region defining a range of positions of the wireless power receiver relative to a position of the wireless power source, and transmitting a signal including output information to a processor or display interface, the output information featuring information about the one class into which the set of voltage values was classified.

### CROSS-REFERENCE TO RELATED APPLICATIONS

This application claims priority to U.S. Provisional Patent Application Nos. 62/367,985, filed on Jul. 28, 2016, and 62/438,103, filed on Dec. 22, 2016, the entire contents of each of which are incorporated herein by reference.

### TECHNICAL FIELD

This disclosure relates to wireless power transfer systems, and in particular, to relative localization of sources and receivers in such systems.

### BACKGROUND

Energy can be transferred from a power source to a receiving device using a variety of known techniques such as radiative (far-field) techniques. For example, radiative techniques using low-directionality antennas can transfer a small portion of the supplied radiated power, namely, that portion in the direction of, and overlapping with, the receiving device used for pick up. In such methods, much—even most—of the energy is radiated away in directions other than the direction of the receiving device, and typically the transferred energy is insufficient to power or charge the receiving device. In another example of radiative techniques, directional antennas are used to confine and preferentially direct the radiated energy towards the receiving device. In this case, an uninterruptible line-of-sight and potentially complicated tracking and steering mechanisms are used.

Another approach to energy transfer is to use non-radiative (near-field) techniques. For example, techniques known as traditional induction schemes do not (intentionally) radiate power, but use an oscillating current passing through a primary coil, to generate an oscillating magnetic near-field that induces currents in a nearby receiving or secondary coil. Traditional induction schemes can transfer modest to large amounts of power over very short distances. In these schemes, the offset tolerances between the power source and the receiving device are very small. Electric transformers and proximity chargers, for example, typically use traditional induction schemes.

Wireless power transfer systems can be used to transfer significant quantities of power between a source resonator and a receiving resonator via large amplitude magnetic fields.

### SUMMARY

Power transfer efficiency between source and receiving resonators depends at least in part on the coupling between the resonators, which in turn is related to the relative position of the resonators. Depending upon the specific geometry of the resonators, coupling between the source and receiving resonators is influenced by the relative distance between the resonators and, in some instances, by the relative angular orientations of the resonators (e.g., in-plane rotation or tilt, and/or out-of-plane rotation or pitch). Both relative linear distances and relative angular orientations can therefore be components of the relative position of one resonator with respect to the other.

For vehicle-implemented wireless charging systems, it can be important to determine the relative position of the source and receiving resonators. Once determined, the relative position can be used to provide guidance feedback to a human vehicle operator or autonomous driving system. The guidance feedback is used to ensure that during operations such as parking, the vehicle is positioned so that a vehicle mounted receiving resonator is properly aligned with, e.g., a ground mounted source resonator, so that wireless power transfer from the source resonator to the receiving resonator to charge batteries on board the vehicle and/or provide operating power to the vehicle occurs efficiently, safely, and in a geometric configuration such that the magnetic fields and EMI emissions outside of the vehicle remain within regulatory limits.

Furthermore, determination of the relative position can be used to provide feedback to the source resonator to ensure that, for example, the power transfer magnetic field is not generated until the source and receiving resonators are closely aligned. This safety measure ensures that humans and animals are not exposed to large amplitude magnetic fields (e.g., outside the parked vehicle chassis), and that inadvertent coupling between such large fields and electrically conductive material in the vicinity of the source resonator is largely prevented.

To provide feedback guidance and determine the relative position of the source and receiving resonators to high accuracy, conventional position measuring methods, including automated driving and parking systems, may not be adequate. For example, such methods may have tolerances of several centimeters, which may not be adequate to ensure that the source and receiver resonators are closely aligned with high reproducibility. Further, such methods can be computationally intensive, implementing the solution of geometrical problems such as triangulation. Even if they yield accurate results, relative position determination can be performed too slowly to provide suitable feedback signals for guidance to a human or autonomous vehicle operation during parking operations.

The methods and systems disclosed herein use measurements from multiple magnetic field sensors, and partition the resulting multi-dimensional measurement space into two or more classes, each of which represents a position class for the relative position of the receiving and source resonators. Repeated sets of sensor measurements are used to update the position class and to determine the relative source-receiver resonator position, providing guidance feedback to the vehicle operator. Relative position and position class determination occurs rapidly (i.e., in real time or near real time) either through reference to a look-up table of calibration measurements, or through a reduced-complexity representation of the measurement space in terms of, for example, a set of support vectors that define boundaries in the measurement space between position classes.

In general, in a first aspect, the disclosure features methods that include: generating a set of Nₘ voltage values using one or more magnetic field detectors, where each voltage value is related in magnitude to an amplitude of a magnetic field between a wireless power source and a wireless power receiver mounted to a vehicle; classifying the set of Nₘ voltage values into one of two classes, where each of the two classes represents a different spatial region defining a range of positions of the wireless power receiver relative to a position of the wireless power source; and transmitting a signal that includes output information to a processor or display interface, the output information featuring information about the one class into which the set of voltage values was classified, wherein the two classes include a first class associated with a range of relative positions of the wireless power receiver that are within a charging zone of the wireless power source, and a second class associated with a range of relative positions of the wireless power receiver that are outside the charging zone of the wireless power source.

Embodiments of the methods can include any one or more of the following features.

The methods can include displaying on a display unit an indicator associated with the one class based on the signal, to provide power transfer information to a vehicle operator or autonomous driving system. The set of Nₘ voltage values can correspond to measurements of the amplitude of the magnetic field in three different directions. The set of Nₘ voltage values can correspond to measurements of the amplitude of the magnetic field in one direction. Nₘ can be greater than or equal to 9 (e.g., greater than or equal to 12).

Each of the classes can be associated with a unique indicator that is displayed on the display unit. The first class can represent a spatial region having a rotationally symmetric shape in a plane parallel to a plane defined by a resonator coil of a source resonator of the wireless power source.

The methods can include classifying the set of Nₘ voltage values using a support vector machine-based classifier. The methods can include training the support vector machine-based classifier by: for each one of a plurality of Nₚ positions of the wireless power receiver relative to the wireless power source, generating a set of Nₘ voltage values using the one or more magnetic field detectors, where each voltage value is related in magnitude to an amplitude of a magnetic field between the wireless power source and the wireless power receiver; assigning the set of Nₘ voltage values at each of the Nₚ positions to one of the two classes; and determining a boundary between the two classes and a set of support vectors associated with the boundary. Classifying the set of Nₘ voltage values into one of multiple classes can include projecting the set of Nₘ voltage values onto the set of support vectors. Nₚ can be 100 or more.

The methods can include generating the magnetic field between the wireless power source and the wireless power receiver using a source resonator of the wireless power source, where each one of the one or more magnetic field detectors is coupled to the wireless power receiver. The wireless power source can include a source resonator, and the methods can include generating the magnetic field between the wireless power source and the wireless power receiver using a secondary coil of the wireless power source, where each one of the one or more magnetic field detectors is coupled to the wireless power receiver.

The wireless power receiver can include a receiver resonator, and the methods can include generating the magnetic field between the wireless power source and the wireless power receiver using a secondary coil of the wireless power receiver, where each one of the one or more magnetic field detectors is coupled to the wireless power source. The wireless power receiver can include a receiver resonator featuring a resonator coil, and the methods can include generating at least some of the set of Nₘ voltage values using the resonator coil of the receiver resonator.

The set of Nₘ voltages values can correspond to a first set of voltage values generated at a first time t₁, and the methods can include, at a time t₂ later than t₁: generating a second set of Nₘ voltage values using the one or more magnetic field detectors, where each voltage value in the second set is related in magnitude to an amplitude of the magnetic field between the wireless power source and the wireless power receiver; classifying the second set of Nₘ voltage values into one of the two classes; and transmitting a signal that includes additional output information to the processor or to the display interface, the additional output information featuring information about the one class into which the second set of voltage values were classified.

A frequency of the magnetic field can be different from a frequency of a power transfer magnetic field that the wireless power source is configured to generate to transfer power from the wireless power source to the wireless power receiver.

Embodiments of the methods can also include any of the other steps and features disclosed herein, including steps and features disclosed in connection with different embodiments, in any combination unless expressly stated otherwise.

In another aspect, the disclosure features wireless power transfer systems that include a wireless power source featuring a source resonator, a wireless power receiver configured to be mounted to a vehicle and featuring a receiver resonator configured to couple to a power transfer magnetic field generated by the wireless power source to transfer power to the wireless power receiver, one or more magnetic field detectors, and one or more processors in communication with the wireless power source, the wireless power receiver, and the one or more magnetic field detectors, where during operation of the system: the one or more magnetic field detectors are configured to generate a set of Nₘ voltage values, where each voltage value is related in magnitude to an amplitude of a measurement magnetic field between the wireless power source and the wireless power receiver; at least one of the one or more processors is configured to classify the set of Nₘ voltage values into one of two classes, where each of the two classes represents a different spatial region defining a range of positions of the wireless power receiver relative to a position of the wireless power source; and at least one of the one or more processors is configured to transmit a signal including output information to a vehicle processor or display interface, the output information featuring information about the one class into which the set of voltage values was classified; and where the multiple classes include a first class associated with a range of relative positions of the wireless power receiver that are within a charging zone of the wireless power source, and a second class associated with a range of relative positions of the wireless power receiver that are outside the charging zone of the wireless power source.

Embodiments of the systems can include any one or more of the following features.

The systems can include a display unit in communication with the one or more processors, where during operation of the system, the display unit is configured to display an indicator associated with the one class to provide power transfer information to a vehicle operator or autonomous driving system.

At least one of the wireless power source and the wireless power receiver can include a secondary coil, and during operation of the system, at least one of the one or more processors can be configured to generate a signal to activate the secondary coil to generate the measurement magnetic field between the wireless power source and the wireless power receiver.

Embodiments of the systems can also include any of the other features disclosed herein, including features disclosed in connection with different embodiments, in any combination unless expressly stated otherwise.

In a further aspect, the disclosure features methods that include generating a set of Nₘ voltage values using one or more magnetic field detectors, where each voltage value is related in magnitude to an amplitude of a magnetic field between a wireless power source and a wireless power receiver mounted to a vehicle, classifying the set of Nₘ voltage values into one of multiple classes, where each of the multiple classes represents a different spatial region defining a range of positions of the wireless power receiver relative to a position of the wireless power source, and transmitting a signal that includes output information to a processor or display interface, the output information featuring information about the one class into which the set of voltage values was classified, where the multiple classes are associated with different trajectories of the vehicle, and where the multiple classes include a first class associated with a trajectory corresponding to forward motion of the vehicle in a straight line, a second class associated with a trajectory corresponding to a combination of forward motion and a right turn of the vehicle, a third class associated with a trajectory corresponding to a combination of forward motion and a left turn of the vehicle, and a fourth class associated with a trajectory corresponding to stopping the vehicle.

Embodiments of the methods can include any one or more of the following features.

The methods can include displaying on a display unit an indicator associated with the one class based on the signal, to provide at least one of vehicle position information and vehicle direction information to a vehicle operator or autonomous driving system. The set of Nₘ voltage values can correspond to measurements of the amplitude of the magnetic field in three different directions. The set of Nₘ voltage values can correspond to measurements of the amplitude of the magnetic field in one direction. Nₘ can be greater than or equal to 9 (e.g., greater than or equal to 12).

The multiple classes can further include a fifth class associated with a trajectory corresponding to backward motion of the vehicle in a straight line, a sixth class associated with a trajectory corresponding to a combination of backward motion of the vehicle and a right turn of the vehicle, and a seventh class associated with a trajectory corresponding to a combination of backward motion of the vehicle and a left turn of the vehicle. Each of the classes can be associated with a unique indicator that is displayed on the display unit.

Each of the second and third classes can represent a different spatial region having a polygonal shape, and at least two sides of each different spatial region can be curved in a plane parallel to a plane defined by a resonator coil of a source resonator of the wireless power source. Shapes of at least some sides of each different spatial region in the parallel plane can be related to a turning radius of the vehicle.

The methods can include classifying the set of Nₘ voltage values using a support vector machine-based classifier. The methods can include training the support vector machine-based classifier by: for each one of a plurality of Nₚ positions of the wireless power receiver relative to the wireless power source, generating a set of Nₘ voltage values using the one or more magnetic field detectors, where each voltage value is related in magnitude to an amplitude of a magnetic field between the wireless power source and the wireless power receiver; assigning the set of Nₘ voltage values at each of the Nₚ positions to one of the multiple classes; and determining a set of boundaries between the multiple classes and a set of support vectors associated with the set of boundaries. Classifying the set of Nₘ voltage values into one of multiple classes can include projecting the set of Nₘ voltage values onto the set of support vectors. Nₚ can be 100 or more.

The methods can include generating the magnetic field between the wireless power source and the wireless power receiver using a source resonator of the wireless power source, where each one of the one or more magnetic field detectors is coupled to the wireless power receiver. The wireless power source can include a source resonator, and the methods can include generating the magnetic field between the wireless power source and the wireless power receiver using a secondary coil of the wireless power source, where each one of the one or more magnetic field detectors is coupled to the wireless power receiver.

The wireless power receiver can include a receiver resonator, and the methods can include generating the magnetic field between the wireless power source and the wireless power receiver using a secondary coil of the wireless power receiver, where each one of the one or more magnetic field detectors is coupled to the wireless power source. The wireless power receiver can include a receiver resonator featuring a resonator coil, and the methods can include generating at least some of the set of Nₘ voltage values using the resonator coil of the receiver resonator.

The set of Nₘ voltages values can correspond to a first set of voltage values generated at a first time t₁, and the methods can further include, at a time t₂ later than t₁: generating a second set of Nₘ voltage values using the one or more magnetic field detectors, where each voltage value in the second set is related in magnitude to an amplitude of the magnetic field between the wireless power source and the wireless power receiver; classifying the second set of Nₘ voltage values into one of the multiple classes; and transmitting a signal that includes additional output information to the processor or to the display interface, the additional output information featuring information about the one class into which the second set of voltage values were classified.

A frequency of the magnetic field can be different from a frequency of a power transfer magnetic field that the wireless power source is configured to generate to transfer power from the wireless power source to the wireless power receiver.

Embodiments of the methods can also include any of the other steps and features disclosed herein, including steps and features disclosed in connection with different embodiments, in any combination unless expressly stated otherwise.

In another aspect, the disclosure features wireless power transfer systems that include a wireless power source featuring a source resonator, a wireless power receiver configured to be mounted to a vehicle and featuring a receiver resonator configured to couple to a power transfer magnetic field generated by the wireless power source to transfer power to the wireless power receiver, one or more magnetic field detectors, and one or more processors in communication with the wireless power source, the wireless power receiver, and the one or more magnetic field detectors, where during operation of the system, the one or more magnetic field detectors are configured to generate a set of Nₘ voltage values, where each voltage value is related in magnitude to an amplitude of a measurement magnetic field between the wireless power source and the wireless power receiver, at least one of the one or more processors is configured to classify the set of Nₘ voltage values into one of multiple classes, where each of the multiple classes represents a different spatial region defining a range of positions of the wireless power receiver relative to a position of the wireless power source, and at least one of the one or more processors is configured to transmit a signal featuring output information to a vehicle processor or display interface, the output information including information about the one class into which the set of voltage values was classified, where the multiple classes are associated with different trajectories of the vehicle, and where the multiple classes include: a first class associated with a trajectory corresponding to forward motion of the vehicle in a straight line; a second class associated with a trajectory corresponding to a combination of forward motion and a right turn of the vehicle; a third class associated with a trajectory corresponding to a combination of forward motion and a left turn of the vehicle; and a fourth class associated with a trajectory corresponding to stopping the vehicle.

Embodiments of the systems can include any one or more of the following features.

The systems can include a display unit in communication with the one or more processors, where during operation of the system, the display unit can be configured to display an indicator associated with the one class to provide at least one of vehicle position information and vehicle direction information to a vehicle operator or autonomous driving system.

At least one of the wireless power source and the wireless power receiver can include a secondary coil, and during operation of the system, at least one of the one or more processors can be configured to generate a signal to activate the secondary coil to generate the measurement magnetic field between the wireless power source and the wireless power receiver.

Each of the second and third classes can represent a different spatial region having a polygonal shape, and at least two sides of each different spatial region can be curved in a plane parallel to a plane defined by a resonator coil of a source resonator of the wireless power source.

Embodiments of the systems can also include any of the other features disclosed herein, including features disclosed in different embodiments, in any combination unless expressly stated otherwise.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### DESCRIPTION OF DRAWINGS

FIG. 1 is a schematic diagram of a wireless power transfer system.

FIG. 2 is a schematic diagram of a vehicle wireless power transfer system.

FIG. 3 is a schematic diagram of a magnetic field sensor.

FIG. 4 is an image showing a magnetic field detector with three field sensors.

FIG. 5 is a schematic diagram of a magnetic field detector.

FIG. 6 is a schematic diagram of a wireless power receiver with three magnetic field detectors.

FIG. 7 is a schematic diagram of a wireless power receiver with four magnetic field detectors.

FIG. 8A is a schematic diagram of a wireless power source.

FIG. 8B is a schematic diagram of a resonator coil of a source resonator.

FIG. 8C is a schematic diagram of another wireless power source.

FIG. 9A is a schematic diagram of a vehicle wireless power transfer system.

FIG. 9B is a schematic diagram of a wireless power receiver.

FIG. 10 is a schematic diagram showing a set of relative calibration positions for a wireless power receiver.

FIGS. 11A-11C are plots showing field amplitude in three different directions for a measurement magnetic field between a wireless power source and receiver.

FIG. 12 is a flow chart showing a series of example steps for determining a relative position of a wireless power receiver.

FIG. 13 is a plot showing actual and calculated positions of a vehicle from a look-up table, for a series of experimental trials.

FIG. 14 is a plot showing the error in position determination for the trials of FIG. 13.

FIG. 15 is a plot showing errors in relative position determination in the x- and y-coordinate directions for the trials of FIG. 13.

FIG. 16 is a schematic diagram showing partitioning of a position feature space into two classes.

FIG. 17 is a schematic diagram showing partitioning of a position feature space into classes by a hyperplane.

FIG. 18 is a schematic diagram showing partitioning of a position feature space into four classes.

FIG. 19 is a schematic diagram showing partitioning of a position feature space into a different four classes.

FIG. 20 is a schematic diagram showing partitioning of a position feature space into 13 classes.

FIG. 21 is a schematic diagram showing partitioning of a position feature space into 9 classes.

FIG. 22 is a schematic diagram showing partitioning of a position feature space into 24 classes.

FIG. 23 is a schematic diagram showing partitioning of a position feature space into 6 classes.

FIG. 24 is a flow chart showing a series of example steps for assigning a class to a relative position of a wireless power receiver.

FIGS. 25A-25E are examples of indicators displayed on a display unit to provide guidance feedback to a vehicle operator.

FIG. 26 is another example of indicators displayed on a display unit.

FIG. 27 is a plot showing a set of simulated parking positions, each classified into one of two classes.

FIG. 28 is a plot showing a set of simulated parking positions, each classified into one of a set of 5 classes.

FIG. 29 is a plot showing a set of simulated parking positions, each classified into one of a different set of 5 classes.

FIG. 30 is a histogram showing a distribution of errors in relative position determination (in distance units from the actual relative position) for each of the simulated parking positions of FIG. 29.

FIG. 31 is a plot showing the actual and determined relative positions of the wireless power receiver for a subset of the simulated parking positions of FIG. 29.

FIG. 32 is a schematic diagram showing a method for determining a vehicle trajectory.

FIG. 33 is a schematic diagram showing another method for determining a vehicle trajectory.

FIG. 34 is a flow chart showing a series of example steps for performing wireless power transfer from a source to a receiver.

Like reference symbols in the various drawings indicate like elements.

### DETAILED DESCRIPTION

### Introduction

Wireless power transfer systems can be used in wide variety of applications to transfer power from one or more sources to one or more receivers. For certain applications, such as providing charging and/or operating power to small handheld devices (e.g., mobile phones and computing devices), the amount of power transferred is relatively modest, and even if power transfer efficiency is less than optimal, these small devices can be easily operated and/or charged.

For applications where larger amounts of power are transferred such as vehicle charging, however, maintaining relatively high efficiency via strong coupling between sources and receivers is linked more strongly to overall performance, safety, and compliance with regulations on human exposure to magnetic fields and electromagnetic interference (EMI). In particular, in systems where power transfer efficiency is lower, the time required to charge batteries connected to the one or more receivers can be significantly longer.

In general, the efficiency of power transfer depends on various factors such as the quality factors Q of the resonators involved and the coupling k between the resonators. Reduced efficiency can result from a variety of factors that lead to a reduction in the quality factors and/or in the coupling. In wireless power transfer systems for vehicle charging, one such factor is misalignment between the source(s) and receiver(s), which reduces the coupling factor between the source(s) and receiver(s). A by-product of reduced coupling is a reduction of the amount of power transferred per unit time.

To ensure proper alignment, it can be important in such systems to determine the relative position(s) of sources and receivers. Once the relative position(s) are determined, the systems can give feedback guidance to human vehicle operators (or autonomous driving systems) to guide the vehicle during operations such as parking, to ensure that proper alignment between the sources and receivers for subsequent charging operations is achieved.

This disclosure will focus, by way of illustrative example, on vehicle charging to discuss various important features and aspects. However, it should be understood that the systems and methods disclosed herein can be used in a wide variety of applications, including applications involving both relatively low power transfer and relatively high power transfer. The examples disclosed herein are merely intended to illustrate these features and aspects in the context of specific situations, and do not limit the systems and methods to particular applications.

### Wireless Power Transfer Systems

A wireless power transfer system generally includes a source which is configured to wirelessly transmit power to a receiver. The source can include a source coil which generates oscillating fields (e.g., electric fields, magnetic fields) in response to electrical currents circulating within the source coil. The generated oscillating fields couple to the receiver and provide power to the receiver through the coupling. To achieve coupling, the receiver typically includes a receiver coil, and the oscillating fields generated by the source coil induce oscillating currents within the receiver coil. In some embodiments, either or both of the source and receiver coils can be resonant, and power transfer from the source to the receiver is achieved through resonant coupling. Alternatively, power transfer can also be achieved through non-resonant coupling between the source and receiver.

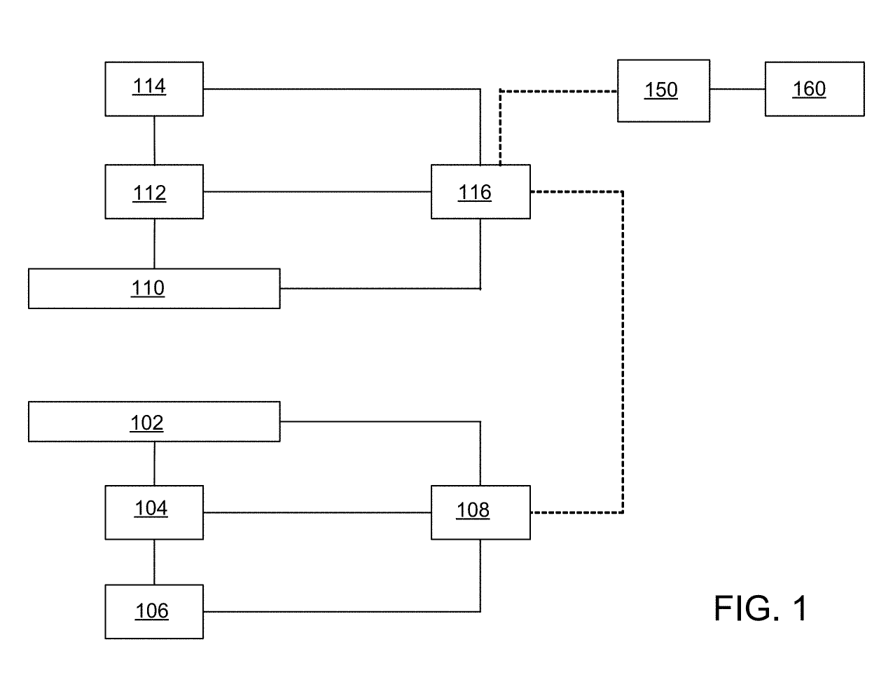

FIG. 1 is a schematic diagram of a wireless power transfer system 100. System 100 includes a source resonator 102 a receiver resonator 110. Source resonator 102 is coupled to power source 106 through coupling circuitry 104, which can include an impedance matching network. Impedance matching networks and methods for impedance matching are disclosed, for example, in commonly owned U.S. patent application Ser. No. 13/283,822, published as US Patent Application Publication No. 2012/0242225, the entire contents of which are incorporated herein by reference. Source resonator 102, coupling circuitry 104, and power source 106 are connected to processor 108, which is configured to control various functions of these elements as will be discussed later.

Receiver resonator 110 is coupled to device 114 through coupling circuitry 112, which can also include an impedance matching network as described above. Typically, device 114 is a battery or power system of, for example, an electric vehicle. Receiver resonator 110, coupling circuitry 112, and device 114 are each connected to processor 116, which is configured to control various functions of these elements as will be discussed later. Processor 116 can, for example, be an embedded processor or processing circuitry within a vehicle. As shown in FIG. 1 by the dotted line, processors 108 and 106 can communicate wirelessly with one another via various wireless communication protocols. Communication between processors 108 and 116 can occur at the frequency of wireless power transfer (i.e., in-band communication) or at a different frequency (i.e., out-of-band communication), via various radio-frequency communication protocols such as WiFi and Bluetooth®.

During operation, power source 106 drives source resonator 102 through coupling circuitry 104 with an oscillating electrical voltage. In response, source resonator 102 (which typically includes one or more source resonator coils) generates oscillating fields (e.g., oscillating magnetic fields). The magnitude of the driving voltage and current provided by power source 106, the frequency of the driving voltage, the resonant frequency of source resonator 102, impedance matching characteristics of coupling circuitry 104, and a variety of other operating parameters are controlled by processor 108.

The oscillating magnetic fields generated by source resonator 102 couple to receiver resonator 110, which also typically includes one or more resonator coils. The fields induce oscillating electrical currents within receiver resonator 110, which are communicated to device 114 through coupling circuitry 112. Processor 116 can control various operating parameters including the magnitude of the voltage and current (e.g., via rectification in coupling circuitry 112) provided to device 114, and impedance matching characteristics of coupling circuitry 112.

As mentioned above, processor 108 can tune the resonant frequency of source resonator 102, e.g., by adjusting tunable components of coupling circuitry 104 such as tunable capacitors and/or inductors. Similarly, processor 116 can tune the resonant frequency of receiver resonator 110 by adjusting tunable components of coupling circuitry 112. By tuning resonant frequencies of the source and receiver resonators relative to the frequency of the driving voltage supplied by power source 106, the efficiency of power transfer from the power source 106 to the device 108 can be controlled. For example, processors 108 and 116 can tune the resonant frequencies of the source and receiver resonators to be substantially the same (e.g., within 0.5%, within 1%, within 2%) as the frequency of the driving voltage.

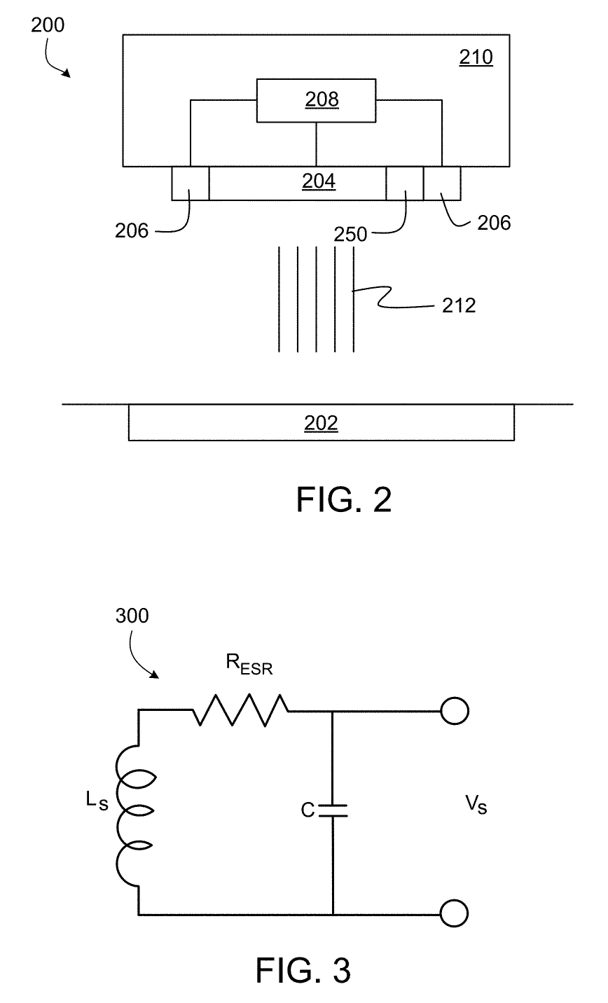

FIG. 2 is a schematic diagram of a vehicle wireless power transfer system 200. System 200 includes a wireless power source 202 (which includes source resonator 102, coupling circuitry 104, power source 106, and processor 106) and a wireless power receiver 204 (which includes receiver resonator 110, coupling circuitry 112, and optionally, processor 116). Wireless power receiver 204 is mounted to the underside of electric vehicle 210 and, as discussed above, is connected to a device such as a battery or other power-consuming component of vehicle 210.

System 200 also includes magnetic field detectors 206 coupled to sensor circuitry 208. In turn, sensor circuitry 208 is connected to processor 116 of wireless power receiver 204. During operation, magnetic field detectors 206 generate electrical signals having magnitudes that are related to the amplitude of a magnetic field 212 generated by wireless power source 202. Sensor circuitry 208 measures the signals generated by magnetic field detectors 206, and communicates the field amplitude measurement signals to processor 116. Processor 116 then uses this information to determine a relative position of wireless power source 202 and wireless power receiver 204, and/or to provide guidance feedback to the operator or autonomous driving mechanism of vehicle 210.

A variety of different magnetic field sensors can be used to measure the amplitude of magnetic field 212. FIG. 3 is a schematic diagram showing an embodiment of a single axis magnetic field sensor 300 that includes an inductor L_{S}, an equivalent series resistance R_{ESR}, and a capacitor C. Oscillating magnetic field flux that extends through the coils of inductor L_{S} generates an AC voltage across the inductor, driving a current in the tank circuit and generating an oscillating voltage V_{S} across the output terminals. Sensor circuitry 208 includes an analog-to-digital converter and high dynamic range, and/or a programmable gain amplifier to measure voltage V_{S}.

Typically, magnetic field 212 has an amplitude profile that is approximately rotationally symmetric about a central axis, with a magnitude that decreases approximately as 1/rⁿ, where r is the distance from the measurement position to the center of the field-generating coil, and n is between 2 and 3, depending upon whether magnetic field 212 is a non-radiative or radiative field, and whether the field frequency is relatively low (e.g., in the kHz range) or relatively high (e.g., MHz or GHz). Because of this strong dependence on r, magnetic field sensors should be capable of detecting fields over a relatively wide dynamic signal range.

To ensure that sensor 300 operates effectively over a relatively wide dynamic range of magnetic field amplitudes, sensor 300 can be operated at or near resonance. The magnitude of the impedance of the circuit shown in FIG. 3, Z_{S}, is given by

$$\vert {Z}_{S} \vert = \sqrt{{( {L}_{S} ω - \frac{1}{ω C} )}^{2} + {R}_{ESR}^{2}} \qquad [ 1 ]$$

where ω is the oscillation frequency of the magnetic field 212. Minimum impedance (corresponding to a maximum signal measured by sensor 300) is achieved when the capacitance of capacitor C is chosen to be at the resonance condition C=1/(ω²L_{S}), so that the impedance magnitude is simply R_{ESR}, thereby significantly increasing the measured voltage V_{S} relative to the voltage that would be measured in an off-resonance condition.

In certain embodiments, to increase the dynamic range over which voltages V_{S} can be measured by sensor 300, sensor circuitry 208 can be configured to perform logarithmic analysis of the measured voltages V_{S}. Operating in logarithmic detection mode can significantly increase the effective range of voltage measurements, and is appropriate because the amplitude of magnetic field 212 decreases in proportion to 1/r³, as explained above.

In some embodiments, sensor circuitry 208 is configured to adjust the capacitance value of capacitor C. Adjustment of capacitance can be performed to tune or de-tune sensor 300 from resonance. Reduction of the measured voltage V_{S} by de-tuning sensor 300 from resonance can be used, for example, to reduce clipping and/or signal distortion when magnetic field 212 is strong in the region of sensor 300. Furthermore, tuning/detuning away from the frequency used for power transfer can be used to protect sensor 300 from high intensity AC magnetic fields used for power transfer.

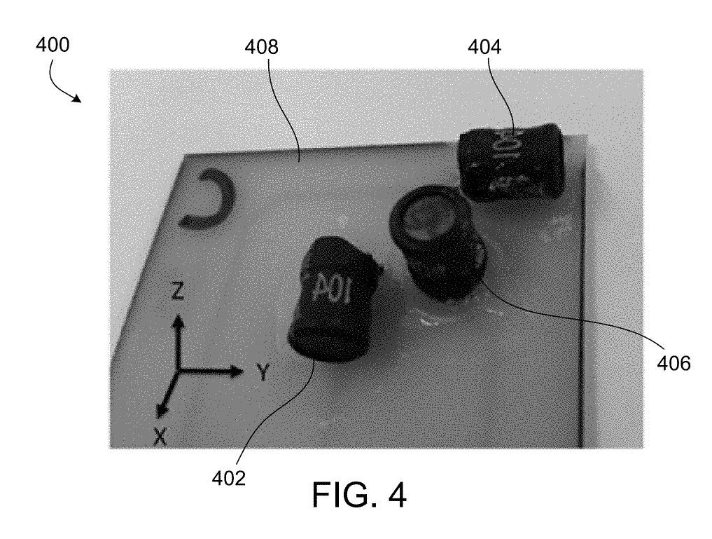

Sensor 300 is a single-axis sensor that generates a voltage V_{S} with a magnitude related to the magnetic field amplitude along a single linear coordinate direction. In some embodiments, each magnetic field detector 206 includes three or four such sensors 300, each oriented along a different coordinate direction, so that each magnetic field detector 206 measures the magnetic field amplitude along three or four directions, which can be orthogonal Cartesian directions. FIG. 4 is an image of a magnetic field detector 400 that includes inductors 402, 404, and 406 oriented such that the axes of the respective inductors fall along the x-, y-, and z-coordinate directions, respectively. Capacitive elements of detector 400 are on the underside of circuit board 408 and are therefore not visible in the image. Each of the magnetic field detectors 206 in FIG. 2 can implemented as shown in FIG. 4, for example.

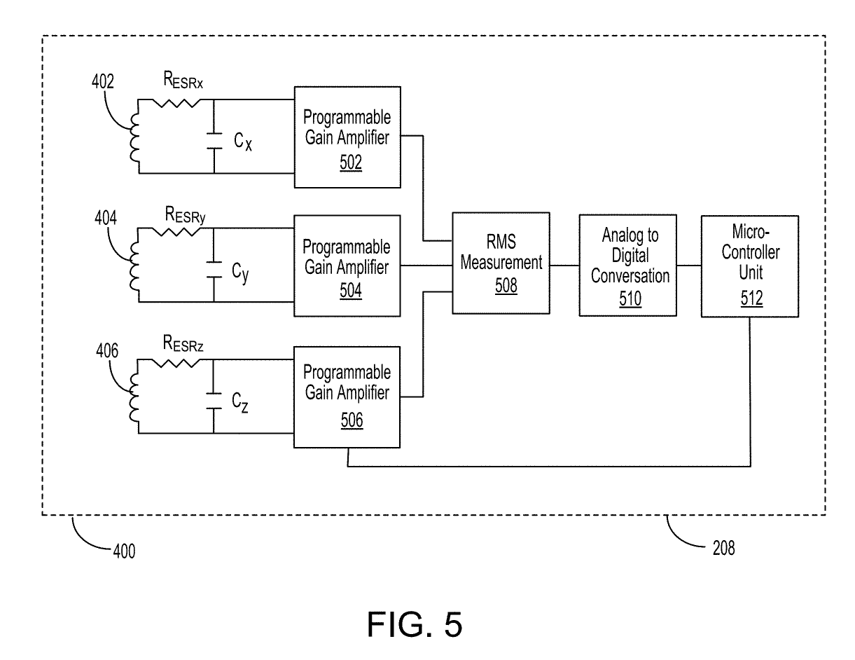

FIG. 5 is a schematic diagram showing detector 400 connected to sensor circuitry 208. Each of inductors 402, 404, and 406 forms a separate tank circuit with corresponding equivalent series resistances (R_{ESRx}, R_{ESRy}, and R_{ESRz}, respectively) and capacitors (Cₓ, C_{y}, and C_{z}, respectively), so that magnetic field detector 400 generates output voltages corresponding to field amplitude measurements along each of the three coordinate directions. The voltages are amplified by amplifiers 502, 504, and 506 (which are typically programmable gain and/or logarithmic amplifiers), measured by RMS measurement unit 508, and digitized by analog-to-digital converter 510. The voltage signals are then transmitted to microcontroller 512, which can adjust the gain values provided by gain amplifiers 502, 504, and 506 individually or together, to provide a suitable dynamic range for magnetic field measurements.

Other types of sensors can also be used in the detectors disclosed herein to detect the amplitude of magnetic field 212. In some embodiments, for example, one or more Hall effect sensors can be used for field detection. In certain embodiments, one or more RSSI sensors—such as those used in Bluetooth® devices, mobile phones, and WiFi devices—can be used.

In certain embodiments, the resonator coil of receiver resonator 110 or the resonator coil of source resonator 102 can be used to detect the amplitude of magnetic field 212. In particular, these resonator coils can be used, for example, to detect the field amplitude along one direction such as the z-coordinate direction.

Different types of sensors can be used in combination with one another for field detection. Alternatively, in some embodiments, the system can include a single detector with a single magnetic field sensor (e.g., a single sensor as shown above, a single Hall effect sensor, or the resonator coil of receiver resonator 110 and/or source resonator 102 used alone).

In general, wireless power receiver 204 can include one or more magnetic field detectors 206. In some embodiments, for example, wireless power receiver 204 includes a single magnetic field detector 206 that measures the amplitude of magnetic field 212 in each of the x-, y-, and z-coordinate directions. In certain embodiments, wireless power receiver 204 includes more than one magnetic field detector 206 (e.g., two or more magnetic field detectors, three or more magnetic field detectors, four or more magnetic field detectors, five or more magnetic field detectors, 8 or more magnetic field detectors, 10 or more magnetic field detectors, 12 or more magnetic field detectors, 15 or more magnetic field detectors, 20 or more magnetic field detectors, 30 or more magnetic field detectors, 50 or more magnetic field detectors, or even more magnetic field detectors).

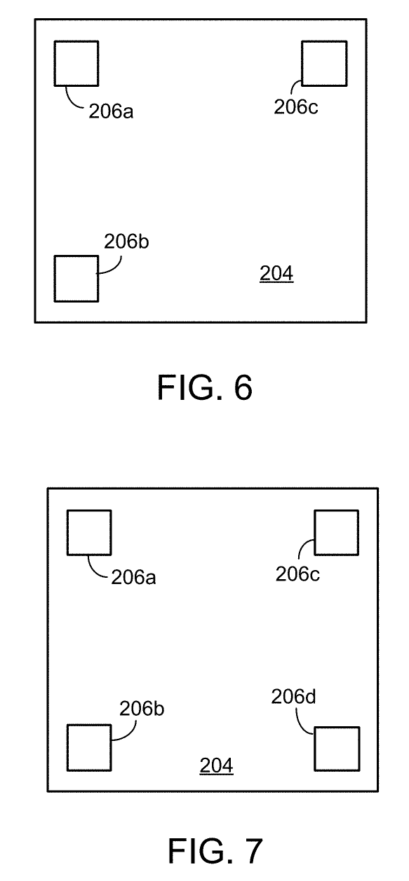

FIG. 6 is a schematic diagram of an embodiment of a wireless power receiver 204 that includes three magnetic field detectors 206a-c, each of which can correspond, for example, to magnetic field detector 400 shown in FIGS. 4 and 5. Each of magnetic field detectors 206a-c measures the amplitude of magnetic field 212 in the x-, y-, and z-coordinate directions at different locations (i.e., adjacent to three of the corners) on wireless power receiver 204.

FIG. 7 is a schematic diagram of another embodiment of a wireless power receiver 204. Receiver 204 in FIG. 7 includes four magnetic field detectors 206a-d located adjacent to each of the corners of receiver 204. Each of detectors 206a-d in FIG. 7 can correspond, for example, to magnetic field detector 400 shown in FIGS. 4 and 5. As in FIG. 6, each of detectors 206a-d in FIG. 7 measures the amplitude of magnetic field 212 in the x-, y-, and z-coordinate directions. Because receiver 204 in FIG. 6 includes 3 detectors 206a-c, receiver 204 in FIG. 6 makes a total of 9 independent field amplitude measurements. Receiver 204 in FIG. 7 includes 4 detectors 206a-d, and therefore makes a total of 12 independent field amplitude measurements.

In FIGS. 6 and 7, detectors 206a-d are positioned adjacent to the corners of receiver 204. More generally, however, detectors can be positioned at any locations on receiver 204, on device 114, and/or on a vehicle to which receiver 204 is mounted. For example, in some embodiments, a detector can be positioned at a geometric center of receiver 204. In certain embodiments, a set of N detectors can be positioned such that each of the N detectors is equidistant from a center of receiver 204. In some embodiments, detectors 206 are positioned along the perimeter of receiver 204, at and/or between the corners of receiver 204. Any arrangement of detectors 206 on receiver 204 can generally be used for measurement of magnetic field amplitudes.

In certain embodiments, all of the detectors 206 used for field amplitude measurements are positioned within the enclosures of the wireless power receiver 204 and/or the wireless power source 202. Implementation in this manner facilitates manufacture and installation of the system on a wide variety of different vehicle types.

In some embodiments, an asymmetric arrangement of detectors 206 can be used to remove orientation ambiguity. Depending upon the geometry of the coil used to generate magnetic field 212, magnetic field 212 may be nearly rotationally symmetric about an axis orthogonal to the plane of wireless power source 202 (i.e., the ground plane). As such, a system of magnetic field detectors positioned symmetrically about a similarly orthogonal axis may generate magnetic field measurements that are similarly symmetric, and therefore present some difficulty in distinguishing the rotational orientation of wireless power source 202 relative to wireless power receiver 204. To eliminate such ambiguity, magnetic field detectors 206 can be positioned such that rotational symmetry of the detectors about such an orthogonal axis does not exist. One example of such an arrangement is shown FIG. 6, although more generally, a wide variety of different non-symmetric arrangements of magnetic field detectors 206 can be implemented.

Although the foregoing discussion focused on detectors that measure the x-, y-, and z-coordinate components of magnetic field 212, more generally the one or more detectors used can be configured to measure only certain amplitude components of the magnetic field. For example, in some embodiments, the one or more detectors can be configured to measure only the z-component of magnetic field 212. When resonator coil 110 is used as a magnetic field detector, for example, resonator coil 110 is typically used to measure only the z-component of the field amplitude. Similarly, other detectors, including those discussed above, can also be used to measure field components along any one or two of the x-, y-, and z-directions.

As a result, the magnetic field detectors can be used to measure field amplitudes along any of a combination of one, two, and three directions. Single-direction detectors can be used to measure the amplitude of magnetic field 212 along any one of the x-, y-, or z-coordinate directions. Double-direction detectors can be used to measure the amplitude of magnetic field 212 along any of the x- and y-coordinate directions, the x- and z-coordinate directions, and the y- and z-coordinate directions.

Combinations of any of the foregoing single-direction and/or multi-direction field detectors can also be used in the systems disclosed herein. In general, the systems can include any number of single-direction, two-direction, and three-direction field amplitude detectors. The single-direction and two-direction detectors can measure field amplitudes in common or different directions, and/or in a combination of common and different directions.

It should also be noted that where single- and multi-direction field amplitude detectors are used, the directions along which field amplitudes are measured are not always orthogonal, and do not always coincide with the coordinate directions. In the examples discussed above, field amplitudes are measured along the x-, y-, and z-coordinate directions, which are mutually orthogonal. More generally, however, field amplitudes can be measured along any direction in the coordinate system of the wireless power transfer system. In addition, for multi-direction detectors, the field amplitudes can be measured along any combination of directions, some or none of which may be orthogonal to one another. Where more than one field detector is used, the one or more directions along which the combination of detectors measures field amplitudes can include one or more common directions, or no common directions.

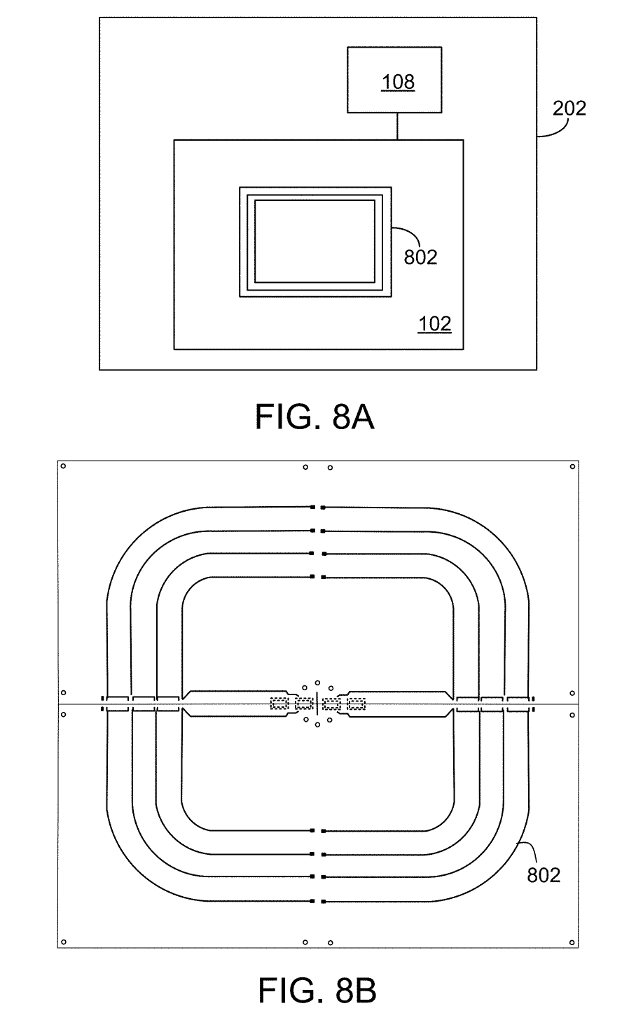

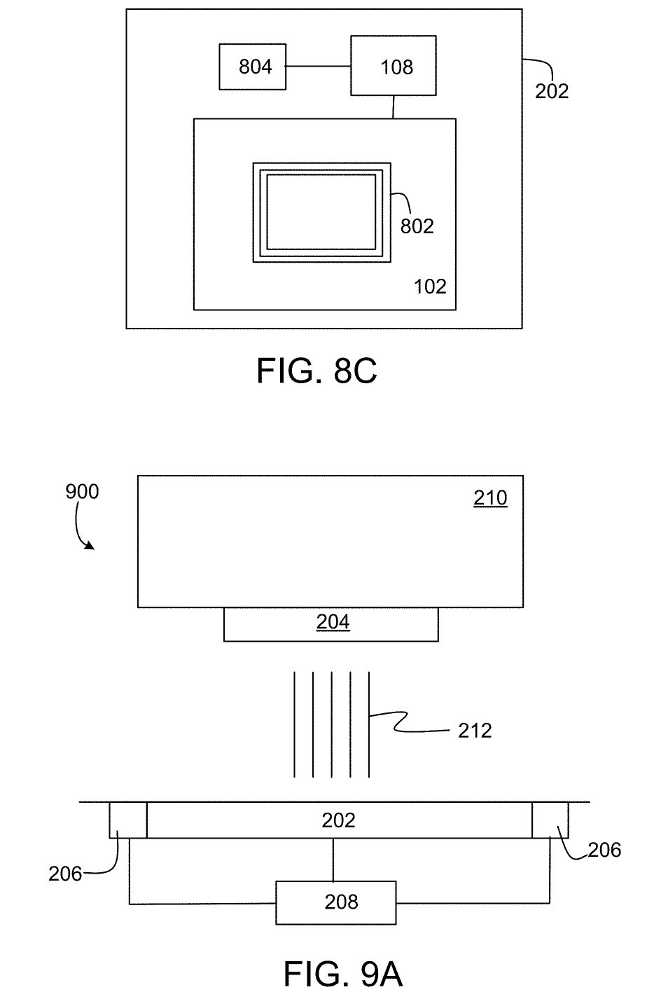

Returning to FIG. 2, magnetic field 212—the amplitude of which is measured by detectors 206—is generally a measurement magnetic field, distinct from the magnetic field that is generated by wireless power source 202 to transfer power to wireless power receiver 204. In some embodiments, wireless power source 202 uses the same resonator coil to generate magnetic field 212 and the power transfer field, but the amplitude of magnetic field 212 is significantly reduced relative to the amplitude of the power transfer field and/or at a different frequency than the frequency of the power transfer field so that the high intensity power transfer field can be passively filtered out to protect system components FIG. 8A is a schematic diagram showing an embodiment of a wireless power source 202. Wireless power source 202 includes a source resonator 102 featuring a source resonator coil 802, and a processor 108 connected to the source resonator 102. Not shown in FIG. 8A, but present in wireless power source 202, are coupling circuitry 104 and power source 106.

A variety of different source resonator coils 802 can be used in wireless power source 202 to generate measurement magnetic field 212. FIG. 8B shows a schematic diagram of an embodiment of source resonator coil 802. In FIG. 8B, source resonator coil 802 includes a plurality of loops extending in a common plane. When driven by an oscillating voltage from power source 106, source resonator coil 802 generates a magnetic field with a magnetic dipole moment that extends in a direction orthogonal to the plane in which the coil loops extend.

To generate measurement magnetic field 212, processor 108 adjusts power source 106 so that the driving voltage applied to source resonator coil 802 is significantly less than the driving voltage that is applied to coil 802 to generate the power transfer field. In this manner, the amplitude of measurement magnetic field 212 that is generated is significantly less than the amplitude of the power transfer field.

In some embodiments, processor 108 can adjust power source 106 to drive source resonator coil 802 at a frequency that is significantly different from the frequency of the oscillating power transfer field. By driving source resonator coil 802 at a different frequency, measurement magnetic field 212 also has a frequency that is significantly different from the power transfer field. Magnetic detectors 206 can be tuned to measure field amplitudes at the frequency of measurement magnetic field 212 rather than at the power transfer field frequency, ensuring that interference from the power transfer field is reduced when magnetic detectors 206 measure field amplitudes, and preventing damage to detectors 206 from coupling to the high amplitude power transfer field.

In general, the frequency of measurement magnetic field 212 can be either higher or lower than the frequency of the power transfer field. As one example, for certain vehicle charging applications, the frequency of the power transfer field that is used to transfer power wirelessly to the vehicle to charge the vehicle's onboard batteries is 85 kHz. The frequency of measurement magnetic field 212, used to determine the relative position of wireless power source 202 and wireless power receiver 204 can be about 5 kHz, about 21 kHz., or even higher, such as about 13.56 MHz.

More generally, the magnitude of the difference between the frequency of the power transfer field and measurement magnetic field 212 can be at least 10 kHz (e.g., at least 20 kHz, at least 40 kHz, at least 60 kHz, at least 80 kHz, at least 100 kHz, at least 200 kHz, at least 500 kHz, at least 1 MHz, at least 5 MHz, at least 10 MHz, at least 20 MHz, at least 30 MHz).

In certain embodiments, rather than using source resonator coil 802 to generate measurement magnetic field 212, wireless power source 202 can include a secondary coil that is used to generate the measurement magnetic field. FIG. 8C shows a schematic diagram of a wireless power source 202 that includes a source resonator 102 with a source resonator coil 802, connected to processor 108. Wireless power source 202 also includes a secondary coil 804 connected to processor 108. As in FIG. 8A, power source 106 and coupling circuitry 104 are not shown.

Secondary coil 804 is connected to power source 106 and/or to a secondary power source, which is in turn connected to processor 108. To activate secondary coil 804 to generate measurement magnetic field 212 (e.g., when a communication link is established between wireless power source 202 and wireless power receiver 204, or when the wireless power system is performing a check for foreign object debris in the vicinity of the system), processor 108 directs power source 106 (or a secondary power source) to drive secondary coil 804 with an oscillating voltage signal. In response to the driving voltage, secondary coil 804 generates measurement magnetic field 212 which is detected by magnetic detectors 206 as discussed above.

In some wireless power sources, secondary coil 804 is used for detecting foreign objects in proximity to the wireless power sources. Secondary coil 804 can thus perform two functions: generating a detection field for foreign object sensing, and generating a measurement field for localization and guidance feedback. As discussed above, while secondary coil 804 can generate a measurement magnetic field 212 with the same nominal frequency as the frequency of the power transfer field, it can be advantageous for processor 108 to adjust the frequency of the driving voltage applied to secondary coil 804 so that measurement magnetic field 212 has a frequency that is different from the frequency of the power transfer field (e.g., 21 kHz vs. 85 kHz, as in the example above). Additional aspects relating to the detection of foreign objects are disclosed, for example, in the following U.S. patent applications, the entire contents of each of which are incorporated by reference herein: Ser. No. 15/297,783, filed on Oct. 19, 2016, and published as US 2017/0141622; Ser. No. 14/706,531, filed on Nov. 12, 2015, and published as US 2015/0323694; and Ser. No. 13/608,956, filed on Sep. 10, 2012, now U.S. Pat. No. 9,442,172.

In some embodiments, to ensure that magnetic field detectors 206 are not damaged by the power transfer field and/or to avoid perturbations to localization measurements from the power transfer field, the frequency of the measurement magnetic field 212 (whether generated by source resonator coil 802 or by secondary coil 804) differs from the frequency of the power transfer field by 20% or more (e.g., 30% or more, 40% or more, 50% or more, 60% or more, 70% or more, 80% or more, 90% or more) of the frequency of the power transfer field.

The wireless power transfer systems discussed above include magnetic field detectors 206 mounted adjacent to the wireless power receiver 204 (e.g., on the chassis of a vehicle), and either source resonator coil 802 or a secondary coil 804 which is part of wireless power source 202 is used to generate measurement magnetic field 212. In some embodiments, however, measurement magnetic field 212 can be generated by wireless power receiver 204, and detected by magnetic field detectors positioned adjacent to (or as part of) wireless power source 202.

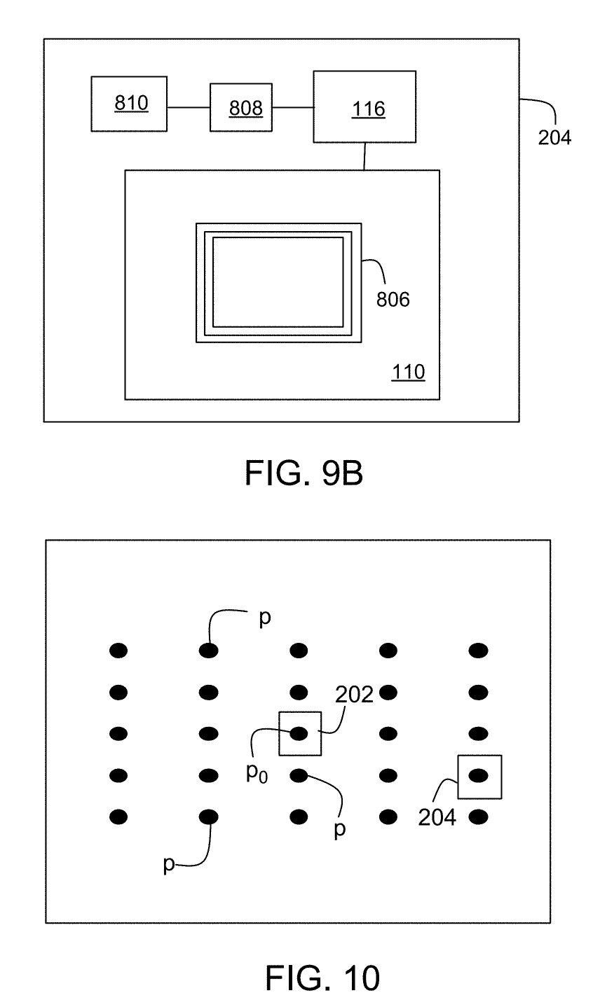

FIG. 9A is a schematic diagram showing a wireless power system 900 that includes a ground-mounted wireless power source 202 and a wireless power receiver 204 mounted to a vehicle 210. Measurement magnetic field 212, generated by wireless power receiver 204, is detected by magnetic field detectors 206, which are coupled to sensor circuitry 208. Sensor circuitry 208 is also connected to wireless power source 202 (i.e., to processor 108). In general, magnetic field detectors 206 and sensor circuitry 208 are similar to the magnetic field detectors and sensor circuitry discussed above.

In certain embodiments, it can be advantageous for magnetic field detectors 206 to be connected to wireless power source 202 rather than wireless power receiver 204. Typically, the cross-sectional area of wireless power source 202 (i.e., the area in the x-y plane) is significantly larger than the cross-sectional area of wireless power receiver 204 in the x-y plane. Thus, with magnetic field detectors 206 located at positions adjacent to the corners of wireless power source 202, the magnetic field detectors 206 detect field amplitudes of measurement magnetic field 212 over a larger effective region in the x-y plane than magnetic field detectors 206 adjacent to the corners of wireless power receiver 204.

FIG. 9B is a schematic diagram of an embodiment of a wireless power receiver 204 that generates measurement magnetic field 212. Receiver 204 includes a receiver resonator 110 that includes a receiver resonator coil 806. Receiver resonator 110 is coupled to processor 116. Coupling circuitry 112, present in wireless power receiver 204, is not shown in FIG. 9B.

Receiver 204 also includes a secondary power source 808 and a secondary coil 810 coupled to processor 116. To generate measurement magnetic field 212, processor 116 directs secondary power source 808 to drive secondary coil 810 with an oscillating voltage, causing secondary coil 810 to generate measurement magnetic field 212 at the frequency of the oscillating driving voltage.

### Relative Position Determination and Guidance Feedback

Providing guidance feedback to a human operator or autonomous driving system of a vehicle is important, as explained above, to ensure that proper alignment between a wireless power source and a vehicle-mounted wireless power receiver is achieved. Proper alignment ensures that power is transferred efficiently and safely to the vehicle, an important consideration when the amount of power transferred is relatively large.

Guidance feedback is also important given the practical situation that arises when a vehicle is driven into position over a ground-embedded wireless power source. As the vehicle approaches the embedded wireless power source, the vehicle operator loses visual contact with the source, and the operator therefore relies exclusively on guidance feedback to properly position the vehicle. Without such feedback, autonomous driving systems would otherwise have to rely on alternative position detection systems to properly position the vehicle relative to the embedded wireless power source, and it is not clear that such alternative systems would enable positioning accuracy sufficient to ensure efficient wireless power transfer to the vehicle, particularly for wireless charging bays that are located in underground and/or indoor parking facilities where GPS and other position-tracking signals are unavailable, and optical or line-of-sight based systems may be impractical.

Certain methods for determining relative position rely heavily on computed metrics based on measurements of various physical parameters. Computationally-expensive methods, however, tend to execute relatively slowly, and do not provide the type of real-time (or near real-time) feedback guidance that is advantageous for vehicle positioning operations. Moreover, it is not clear that such methods can determine relative positions with sufficiently high accuracy to ensure that power is transferred wirelessly to the vehicle once it is parked. The accuracy of such methods can be compromised due to the presence of sensor noise that arises from, for example, variations in vehicle chassis, the surrounding electromagnetic environment, nearby foreign objects and debris, and other factors that affect sensor measurements.

Disclosed herein are methods that provide real-time (or near real-time) relative position determination and/or guidance feedback to the operator of a vehicle for positioning the vehicle relative to a wireless power source. Variations in the environment and in field sensor operation are incorporated into calibration data so that the methods are robust even in the presence of perturbing objects and even when individual sensors are not operating as originally intended. Moreover, the calibration data can be used to construct a robust, abstract representation of the vehicle environment in which relative positions can be determined rapidly.

Methods for measuring relative positions and providing guidance feedback will be discussed herein in the context of measuring the position of a vehicle-mounted wireless power receiver relative to a fixed-position (i.e., ground embedded) wireless power source. However, it should be understood that the methods described can also be applied to the determination of the position of a wireless power source relative to a fixed-position wireless power receiver, and/or to the determination of the relative positions of a wireless power source and a wireless power receiver relative to another fixed-position object or reference point. Effectively, there is little difference between such variations, except the choice of reference location that establishes the origin of the relative position measurement coordinate system.

To determine the position of a wireless power receiver relative to a wireless power source, calibration information is first measured for the wireless power source and receiver. In some embodiments, the calibration information is measured with the wireless power transfer system installed on the specific vehicle chassis intended for deployment, which can significantly increase the accuracy of the calibration information measured, thereby improving system performance. To measure the calibration information, the wireless power source is activated and generates measurement magnetic field 212. The wireless power receiver is positioned at each of a set of Nₚ locations p relative to the wireless power source and at each location p, the magnitude of the measurement magnetic field 212 is measured by each of the magnetic field detectors 206 connected to the wireless power receiver. As discussed above, in general, magnetic field detectors 206 can be used to measure field amplitudes along a wide variety of directions which may be orthogonal or non-orthogonal. Further, different combinations of magnetic field detectors can be used to measure field amplitudes along various combinations of directions; combinations of single- and multi-direction field detectors can be used. For purposes of clarity, the discussion below will focus on using multiple field detectors, each of which measures field amplitudes in the x-, y-, and z-coordinate directions. However, it should be understood that the methods and systems disclosed herein can also be used with detectors that measure field amplitudes along any one or more directions and combinations of directions, as discussed above.

FIG. 10 is a schematic diagram that shows the calibration measurement procedure. In FIG. 10, wireless power source 202 is located at point p₀, which is effectively the origin of the measurement coordinate system. Wireless power receiver 204 is positioned at each of Nₚ points p, where the magnitude of measurement magnetic field 212 is measured by each of the magnetic field detectors 206 (not shown in FIG. 10). FIG. 10 shows a two-dimensional grid of Nₚ points but in general, measurements are made over a three-dimensional grid of Nₚ points that extends along each of the x-, y-, and z-directions, or over a four-dimensional grid of Nₚ points that extends along the three linear coordinate directions above, and also over a range of rotational (or “yaw”) angles, θ, of wireless power receiver relative to wireless power source.

Thus, at each of Nₚ measurement grid points (x,y,z) or (x,y,z,θ), N_{d} detectors of the wireless power receiver 204 make 3N_{d}=Nₘ measurements of measurement magnetic field 212 (i.e., field amplitude measurements in each of the three linear coordinate directions). Each of the Nₘ measurements is a voltage generated by a magnetic field sensor, as discussed above.

Following completion of the calibration measurements, the complete set of calibration measurements L can be expressed as

L=[Nₘ×Nₚ] [2]

This set of calibration measurements encodes variations in relative position (i.e., linear displacements and yaw rotations) between wireless power source 202 and wireless power receiver 204 in measured voltages. That is, each relative position is associated with a set of voltages measured by each of the N_{d} detectors of wireless power receiver 204.

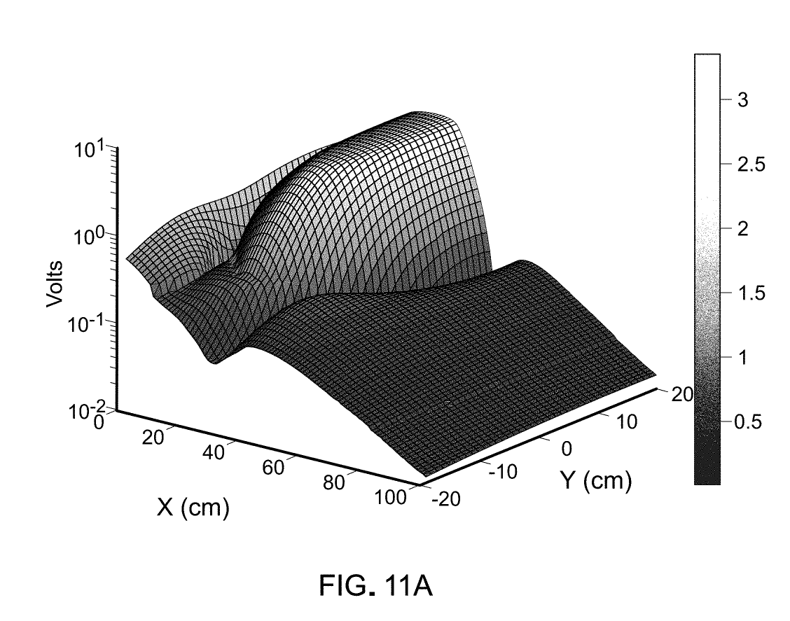

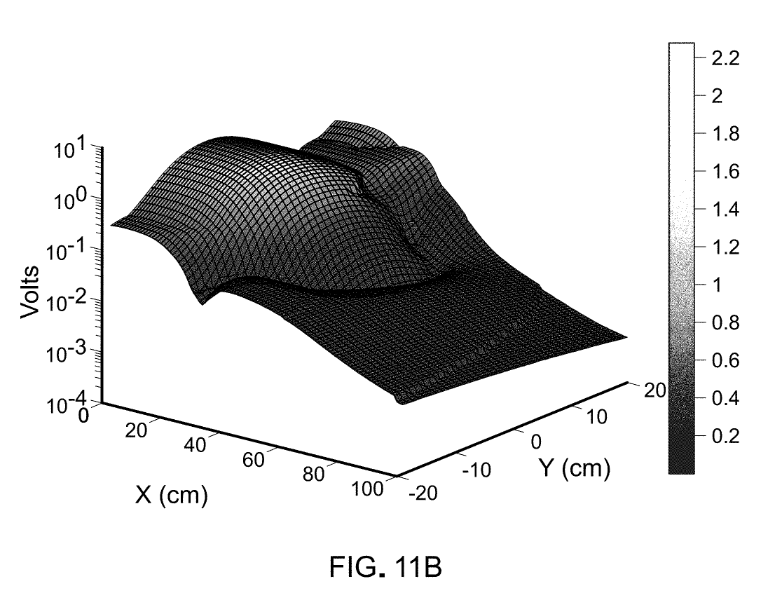

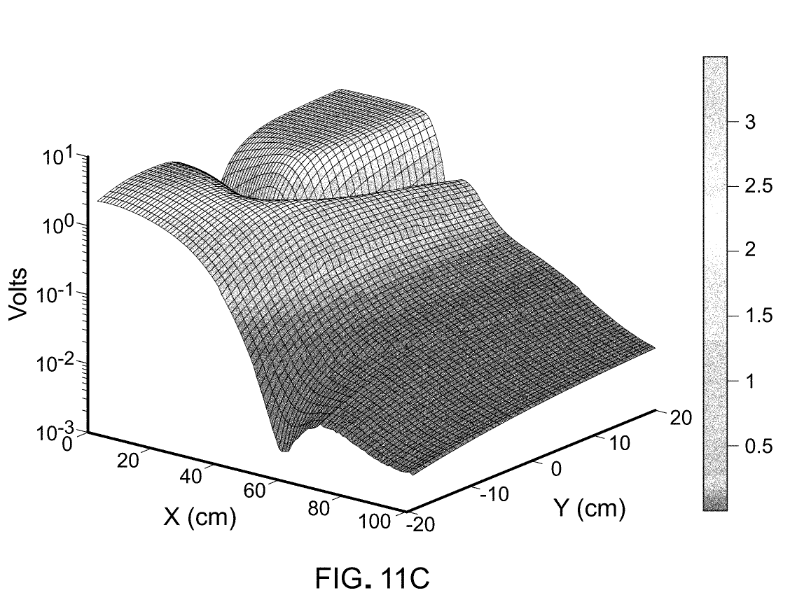

FIGS. 11A, 11B, and 11C are plots showing measured voltage signals corresponding to field amplitudes of measurement magnetic field 212 in the x-, y-, and z-coordinate directions, respectively, as measured by the three magnetic field sensors of a magnetic field detector. The voltages were measured in a 40 cm×100 cm region, with a 1 cm distance in both the x- and y-directions between adjacent positions of the wireless power receiver relative to the wireless power source.

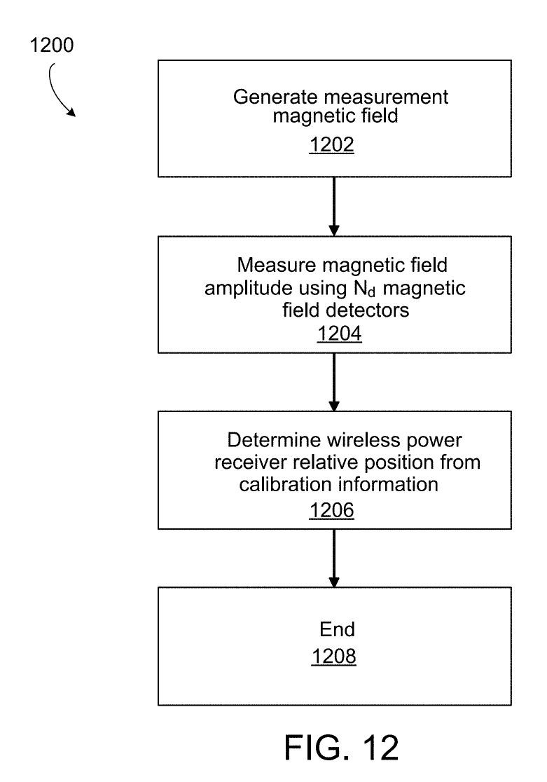

After all of the calibration data have been collected, the position of wireless power receiver relative to wireless power source is determined. FIG. 12 is a flow chart 1200 that shows one example method for determining the relative position of the wireless power receiver. In step 1202, with the wireless power receiver located at an unknown position relative to the wireless power source, measurement magnetic field 212 is generated using any of the methods discussed previously.

Next, in step 1204, the N_{d} detectors associated either with the wireless power receiver or wireless power transmitter are used to measure the amplitudes of the measurement magnetic field 212 in each of the x-, y-, and z-coordinate directions, yielding a total of Nₘ measurements of the field amplitude. In effect, this step yields a [Nₘ×1] measurement vector that corresponds to the unknown relative position of the wireless power receiver.

Then, in step 1206, the relative position of the wireless power receiver is determined based on the calibration information and the Nₘ field amplitude measurements. Various methods can be used to make the relative position determination. In some embodiments, for example, the relative position of the wireless power receiver can be determined with reference to a look-up table that includes the calibration information. That is, the Nₘ field amplitude measurements are compared to sets of Nₘ field amplitude measurements in the calibration information that correspond to known relative positions of the wireless power receiver.

To compare a set of Nₘ field amplitude measurements to individual sets of calibration measurements, vector norms can be used. For example, the vector norm V between a set of field amplitude measurements M₁ . . . M_{Nm} and a set of calibration measurements L₁ . . . L_{Nm} can be calculated as

$$V = \frac{\sqrt{{( {L}_{1} - {N}_{1} )}^{2} + … + {( {L}_{Nm} - {N}_{Nm} )}^{2}}}{\vert M \vert} \qquad [ 3 ]$$

where M is a vector whose elements are the set of field amplitude measurements M₁ . . . M_{Nm}.

The closest match between a set of Nₘ field amplitude measurements and a set of Nₘ calibration measurements is the one for which the value V is smallest. In some embodiments, the relative position associated with the set of calibration measurements that corresponds to the closest match to the field amplitude measurements is assigned as the relative position of the wireless power receiver.

In certain embodiments, to allow for effective interpolation between discrete positions within the set of calibration measurements, the positions of the T closest matches within the set of calibration measurements to the field amplitude measurements are averaged, and the average position is assigned as the relative position of the wireless power receiver. Averaging positions in this manner can also help to de-noise the estimate of the relative position of the wireless power receiver. Typically, the number of positions T that are averaged is relatively small, e.g., 10 or less (8 or less, 6 or less, 5 or less, 4 or less, 3 or less).

After the relative position of the wireless power receiver has been determined, the procedure ends at step 1208.

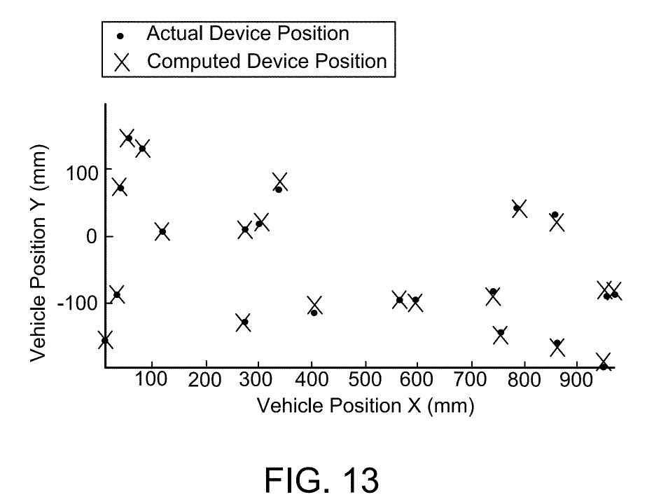

FIG. 13 is a plot showing a series of 22 individual trials in which the position of a wireless power receiver relative to a wireless power source was determined using the look-up table method discussed above. Each trial was conducted at the same z-coordinate value and the same yaw angle θ, but at a different x- and y-coordinate location, and for each location, the relative positions associated with the 3 closest matches between set of calibration measurements and the field amplitude measurements were averaged to determine the relative position of the wireless power receiver.

In FIG. 13, the crosses show the calculated relative positions of the wireless power receiver and the dots show the actual relative positions of the receiver. As is evident from the plot, for distances between the wireless power source and receiver of up to 1 meter, the relative position of the wireless power receiver was accurately determined.

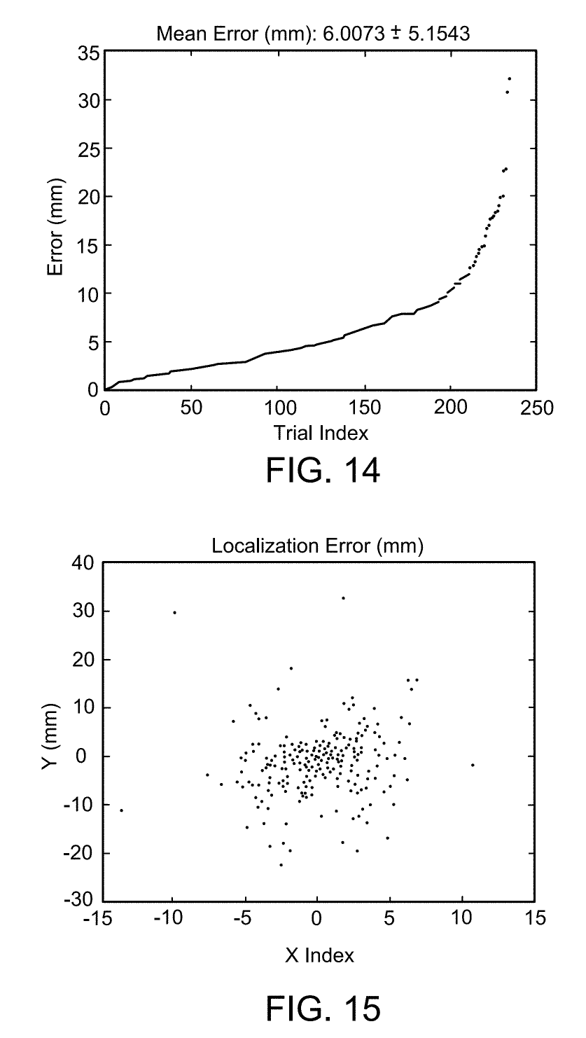

To further quantify the error associated with relative position determination using the methods discussed above, 234 trials were conducted in which the wireless power receiver was positioned at a randomly chosen, known position relative to the wireless power source, and the relative position of the wireless power source was determined based on calibration information in a look-up table as discussed above. FIG. 14 is a plot showing the error in position determination for each of the 234 trials. The average error magnitude was 6 mm with a standard deviation of 5.15 mm over a region that was 40 cm by 100 cm. Position determination was accurate to within 1 cm in 85% of the trials.

FIG. 15 is a plot showing the errors in relative position determination for the wireless power receiver in the x- and y-coordinate directions. In all trials, the relative position of the wireless power receiver was determined accurately to within 35 mm.

In certain embodiments, rather than calculating the relative position of the wireless power receiver in a coordinate system, it can be more efficient and more informative to determine a class associated with the relative position of the wireless power receiver. The determined class can be used by processors 108 and 116 to adjust a variety of different operating parameters, and to provide feedback guidance to a human operator of a vehicle or an autonomous driving system.

Support vector machines can be used to associate various classes with relative positions of a wireless power receiver, and to “classify” a relative position of a wireless power receiver at an unknown location. A support vector machine is a supervised-learning classification algorithm that, once trained with calibration data, provides a technique for partitioning a feature space into clusters, each of which is associated with a different class or label. The support vectors construct the boundaries of an optimal separating hyperplane between the classes. Further, nonlinear mapping of the voltage measurement space can be accomplished using the “kernel trick” so that classification can occur even when the voltage measurement space is not linearly separable into respective classes. After support vectors have been determined, classification of a new set of measurements can be performed by calculating projections of the measurements onto the support vectors.

As an initial step in determining a class associated with the relative position of the wireless power receiver, calibration measurements are performed in the manner discussed above to obtain a set of calibration data consisting of Nₘ voltage measurements at each of Nₚ relative positions of the wireless power receiver. Margins representing boundaries between classes within this calibration data set can be very tightly defined by the support vectors, so that classification is highly accurate and reproducible.

In general, the number of relative positions of the wireless power receiver, Nₚ, can be selected as desired to provide calibration data of suitable granularity for classification operations. In some embodiments, for example, Nₚ is 30 or more (e.g., 50 or more, 100 or more, 500 or more, 1000 or more, 3000 or more, 5000 or more, 10,000 or more, 15,000 or more, 20,000 or more, 30,000 or more, 50,000 or more, or even more).

After the calibration data has been obtained, the next step is to partition the feature space associated with the calibration data into a set of classes. The classes can represent a variety of states associated with the relative position of the wireless power receiver. In general, the feature space, because it represents the relative position of the wireless power receiver, is smooth and continuous. As a result, when the position of the wireless power receiver relative to the wireless power source changes even slightly (i.e., via a linear displacement and/or rotation) or the electromagnetic environment is perturbed by debris in the vicinity of the wireless power receiver, these perturbations will typically fall between the support vectors given the nonlinear partitioning of the feature space by the support vector machine, and the class associated with the position of the wireless power receiver is still correctly determined.

A variety of different partitioning schemes can be used to assign classes to points in the feature space, i.e., the (x,y,z) space or (x,y,z,θ) space, at which the calibration data was measured. In general, to perform this partitioning, each of the points at which the wireless power receiver was positioned when field amplitudes of measurement magnetic field 212 were measured using magnetic field detectors 206 is assigned to one of S classes. The S classes can generally be selected as desired to reflect subsequent operations to be performed by the wireless power transfer system and/or guidance feedback to be provided to the operator or driving system of the vehicle in response to subsequent measurements when the wireless power receiver is at an unknown relative position. Several examples of sets of S classes will be discussed below.

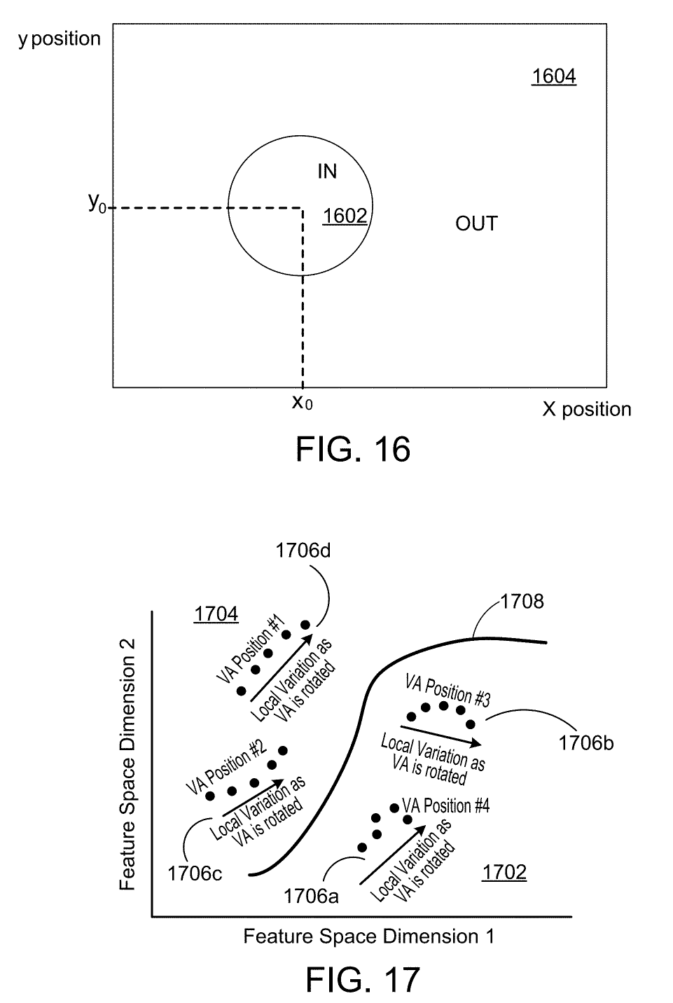

In some embodiments, each location of the wireless power receiver in the calibration data is assigned to one of two classes: a first class labeled “IN” and representing a spatial region within which charging power is transferred to the wireless power receiver, and a second class labeled “OUT” and representing a spatial region within which charging power is not transferred to the wireless power receiver. FIG. 16 shows a schematic diagram of an example of the two classes in the x- and y-coordinate dimensions. The first class 1602 represents the region in which wireless power is transferred; no power is transferred when the wireless power receiver is located within the region corresponding to second class 1604. In FIG. 16, the wireless power source is located at position (x₀,y₀)—at the center of the region corresponding to the first class 1602. More generally, however, the wireless power source can be located at any position relative to the two regions.

The region corresponding to the first class 1602 is circular in shape in FIG. 16, by virtue of the symmetry of the power transfer magnetic field in the x-y plane. Specifically, where the power transfer magnetic field has circular symmetry in the x-y plane, the region corresponding to the first class 1602 typically also has circular symmetry in the x-y plane. In some embodiments, the cross-sectional shape of the region corresponding to the first class 1602 can have another shape, such as a rectangular, square, elliptical, oval, or another shape, in the x-y plane. It should be noted that for purposes of this discussion, the z-coordinate represents the “height” dimension along which the wireless power source and receiver are vertically separated (i.e., the dimension nominally orthogonal to the ground), while the x-y plane is the plane orthogonal to the z-coordinate direction and nominally parallel to the ground. Yaw rotations θ are measured about the z-coordinate axis in the x-y plane.

The classes shown in FIG. 16 can be used to create a straightforward support vector machine (SVM) which partitions the spatial coordinate space into two classes, each corresponding to a well-defined set of positions of the wireless power receiver relative to the wireless power source. Subsequently, when the wireless power receiver is at an unknown relative position during a maneuvering (i.e., parking) operation, field amplitude measurements for the measurement magnetic field 212 by magnetic field detectors 206 at the unknown relative position can be used together with the calibration information to assign the wireless power receiver's relative position to one of the two classes, without performing a calculation of the wireless power receiver's position in (x,y,z) space or (x,y,z,θ) space.

FIG. 17 shows a schematic diagram of a hypothetical two-dimensional position-based feature space, in which points in the feature space have been assigned to one of two classes. First class 1702 represents relative positions of the wireless power receiver at which power is transmitted by the wireless power source, while second class 1704 represents relative positions at which power is not transmitted. Four different relative positions 1706a-d of the wireless power receiver within the feature space of FIG. 17 are also shown. Relative positions 1706a and 1706b are within the first class 1702, while relative positions 1706c and 1706d are within the second class 1704. At each of the relative positions, a certain amount of variability was observed due to variations in height (i.e., the z-coordinate) and yaw (i.e., the θ coordinate), along with perturbations due to changes in the electromagnetic environment of the wireless power receiver due to debris and variations in the manufacture of the system, the vehicle chassis, and/or the magnetic field detectors.

A hyperplane 1708 separates the first and second classes 1702 and 1704 in FIG. 17. In general, hyperplane 1708 is a complex multi-dimensional surface defined or encoded by the support vectors of the SVM. Where the feature space is partitioned into more than two classes, multiple hyperplanes encoded by the support vectors define boundaries between the various classes. Thus, by determining the set of support vectors associated with the SVM, the boundaries between each of the feature space classes can be determined and stored. In effect, the support vectors form an abstract representation of the feature space classes, which can then be used to rapidly determine which of the defined classes should be assigned to the wireless power receiver when the wireless power receiver is at an unknown relative position.

The two classes in FIG. 16 are defined according to operational functions of the wireless power transfer system, i.e., whether or not the wireless power source transmits power to the wireless power receiver. When the wireless power receiver position is assigned to the first class 1602, power transfer occurs; when the wireless power receiver position is assigned to the second class 1604, power transfer does not occur.

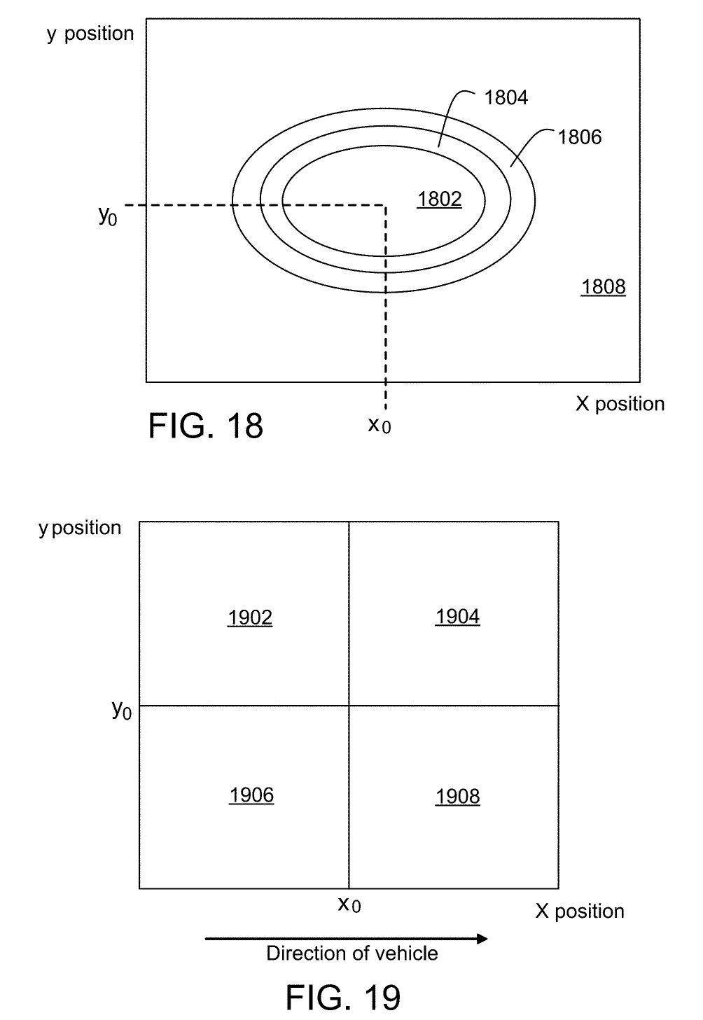

In some embodiments, classes are defined in the position feature space according to guidance feedback that is provided to the human operator or autonomous driving system of the vehicle. In particular, the defined classes represent information about wireless charging operations and/or driving/positioning instructions to ensure alignment between the wireless power source and receiver. FIG. 18 shows a schematic diagram in which the position feature space is partitioned into four classes based on expected power transfer efficiency from the wireless power source to the wireless power receiver. Note that only a portion of the total position feature space (a section along the x-y plane) is shown in FIG. 18. The wireless power source is located at position (x₀,y₀).

The first class 1802 represents relative positions of the wireless power receiver at which the efficiency of power transfer is expected to be high. The second and third classes 1804 and 1806, respectively, represent relative positions of the wireless power receiver at which the efficiency of power transfer is expect to be medium and low, respectively. The fourth class 1808 represents the set of relative positions of the wireless power receiver at which power transfer is not expected to be possible.

When the wireless power receiver is assigned to one of the classes shown in FIG. 18 based on its relative position, the assigned class can be reported to the human operator or autonomous driving system of the vehicle, and the human operator or autonomous driving system can then determine whether the relative position of the wireless power receiver is adequate for power transfer or whether, for example, another attempt at parking the vehicle should be made. As an example, when the wireless power receiver is assigned to class 1802 or 1804, no additional parking attempt may be made, but when the wireless power receiver is assigned to class 1806 or 1808, the human operator or autonomous driving system may elect to make another attempt to park the vehicle to improve alignment between the wireless power source and the wireless power receiver.

In some embodiments, classes can be defined according to guidance feedback to be provided to the human operator or autonomous driving system as the vehicle is being positioned (i.e., parked) overtop of a wireless power source. In particular, the classes can correspond to specific dynamic driving directions to correct the course of the vehicle during such operations. FIG. 19 is a schematic diagram showing partitioning of the position feature space into four classes based on driving directions to be provided to the human operator or autonomous driving system. As above, the wireless power source is located at position (x₀, y₀) in the coordinate system of FIG. 19, and FIG. 19 shows only a section of the complete feature space in a direction along the x-y plane. The vehicle is moving along the +x direction in FIG. 19.

When the wireless power receiver is assigned to class 1902, feedback instructions are provided indicating that the vehicle should move forward and turn to the right. When the wireless power receiver is assigned to class 1904, feedback instructions are provided indicating that the vehicle should move backward and turn to the right. When the wireless power receiver is assigned to class 1906, feedback instructions are provided indicating that the vehicle should move forward and turn to the left. When the wireless power receive is assigned to class 1908, feedback instructions are provided indicating that the vehicle should move backward and turn to the left.

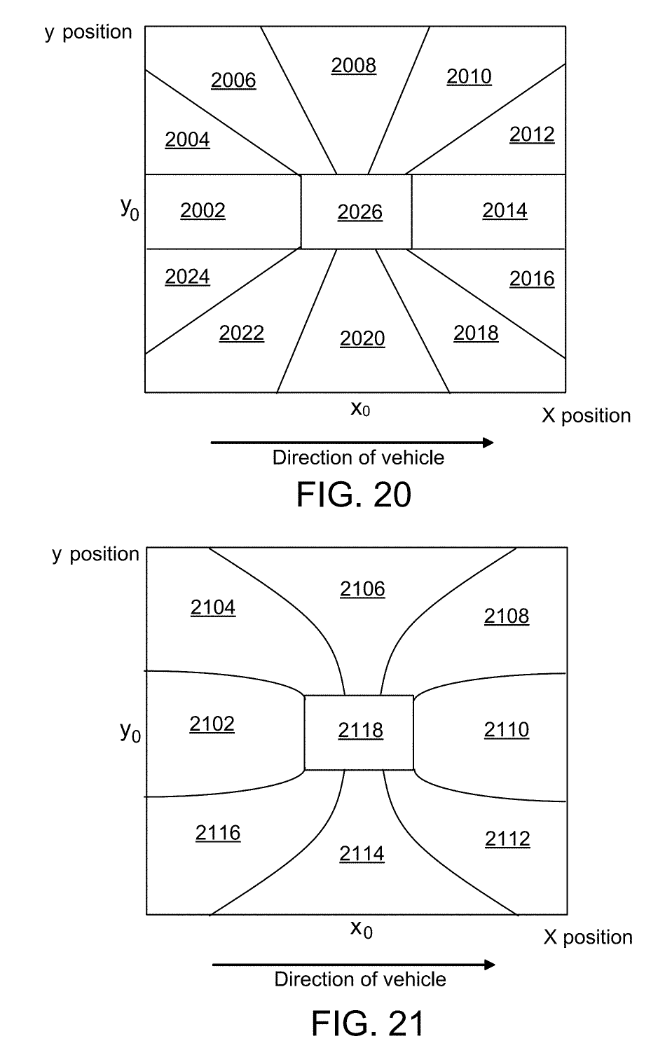

For purposes of providing more complex guidance feedback to the human operator or autonomous driving system, larger and more geometrically complex sets of classes can also be used to partition the position feature space. FIG. 20 is a schematic diagram showing partitioning of the position feature space into a set of 13 classes, each of which is associated with different guidance feedback provided to the human operator or autonomous driving system when the relative position of the wireless power receiver is assigned to the class. The feedback guidance corresponding to each of the classes in FIG. 20 is as follows:

2002: continue forward in a straight trajectory

2004: continue forward and turn right slightly

2006: continue forward and hard turn right

2008: abort parking attempt and reverse direction

2010: reverse direction and hard turn right

2012: reverse direction and slight turn right

2014: reverse direction, maintain straight trajectory

2016: reverse direction and slight turn left

2018: reverse direction and hard turn left

2020: abort parking attempt and reverse direction

2022: continue forward and hard turn left

2024: continue forward and turn left slightly

2026: stop—source and receiver aligned

The position feature space can also be partitioned according to many other sets of classes based on the desired feedback guidance to be provided to the human operator or autonomous driving system. For example, referring to FIG. 20, in some embodiments, classes 2004 and 2006 are combined into a single class (e.g., continue forward and turn right), classes 2010 and 2012 are combined into a single class (e.g., reverse direction and turn right), classes 2016 and 2018 are combined into a single class (e.g., reverse direction and turn left), and classes 2022 and 2024 are combined into a single class (e.g., continue forward and turn left).

FIG. 21 is a schematic diagram showing partitioning of the position feature space into a set of 9 classes, each of which is associated with feedback guidance to be provided to the human operator or autonomous driving system. The classes shown in FIG. 21 correspond to the following feedback guidance:

2102: continue forward

2104: continue forward and turn right

2106: abort and reverse direction

2108: reverse direction and turn right

2110: reverse direction

2112: reverse direction and turn left

2114: abort and reverse direction

2116: continue forward and turn left

2118: stop—source and receiver aligned

The shapes of the boundaries between classes in FIG. 21 are curved (i.e., nonlinear), in contract to the straight line boundaries between classes in FIG. 20. The positions of the boundary lines in both FIGS. 20 and 21 can depend, in some embodiments, on the nature of the vehicle. For example, large vehicles have larger turning radii than smaller vehicles. Accordingly, the sizes of classes corresponding to “hard turns” may be larger for feedback guidance to a larger vehicle than the sizes of the same classes when feedback guidance is provided to a smaller vehicle. Further, the curvature of the class boundaries in FIG. 21 may be larger for larger vehicles, due to the reduced turning radius of such vehicles relative to smaller vehicles.

As is evident from the foregoing discussion, the shapes of the classes for purposes of feedback guidance can depend at least in part on the nature of the vehicle being guided. Thus, the class shapes can be associated with particular vehicle types in the same manner than the measured calibration information can also be associated with a particular vehicle type. For different vehicle types (e.g., a large truck instead of a small car), different calibration information is measured and a different set of classes may be defined to provide feedback guidance in each case.

More generally, for purposes of feedback guidance, the set of classes into which the position feature space is partitioned typically includes at least certain class types. For example, referring again to FIG. 21, the set of classes typically includes at least one class (e.g., class 2118) that corresponds to alignment between the wireless power source and receiver, at least one class that corresponds to a forward vehicle guidance trajectory with no turning (e.g., class 2102), at least one class that corresponds to a right turn vehicle guidance trajectory (e.g., class 2104), and at least one class that corresponds to a left turn vehicle guidance trajectory (e.g., class 2116). As shown in FIGS. 20 and 21, the set of classes can also include various additional classes to provide further guidance feedback to the human operator or autonomous vehicle driving system.

In some embodiments, the position feature space is partitioned into a set of classes for purposes of localization of the wireless power receiver. In general, the set of classes forms a spatial grid within the position feature space such that when the wireless power receiver is assigned to a particular class, localization of the wireless power receiver is achieved to within a tolerance that corresponds to the resolution of the grid defined by the set of classes.

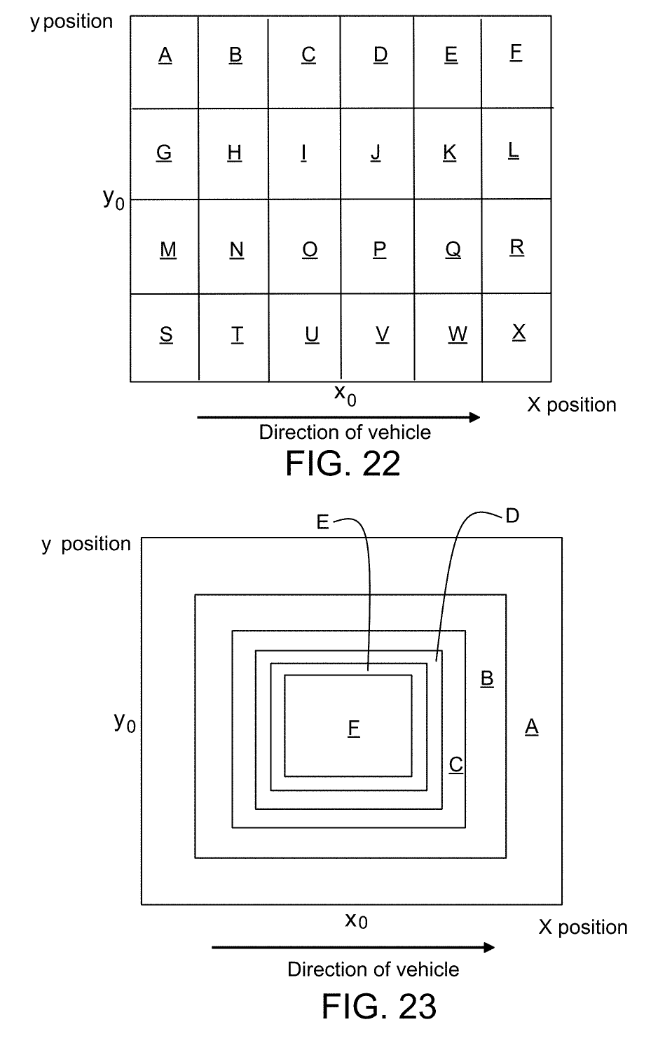

FIG. 22 is a schematic diagram showing partitioning of the position feature space into a set of 24 classes, forming a spatial grid within the position space. The classes are labeled A-X, and each is of the same spatial dimensions (e.g., 5 cm by 5 cm in FIG. 22). Thus, when the wireless power receiver is assigned to one of the classes A-X, the position of the wireless power receiver is determined to within the resolution of the spatial grid formed by the set of classes (e.g., to within 5 cm).

While the classes shown in FIG. 22 are square in shape, more generally, the classes can be rectangular, circular, hexagonal, or can have any other regular or irregular cross-sectional shape in the x-y plane. Moreover, while the classes in FIG. 22 each have the same cross-sectional shape, more generally certain classes can have shapes that differ from the shapes of other classes, depending upon the type of localization information that is desired. For example, FIG. 23 is a schematic diagram showing partitioning of the position feature space into a set of 6 classes A-F based on relative distance from the location (x₀,y₀) of the wireless power source. The cross-sectional area of each of the classes in the x-y plane is not uniform. For positions that are relatively far from the wireless power source (i.e., class A), the resolution of position localization is lower, as alignment between the source and receiver in this region does not occur. For positions that are progressively closer to the location of the wireless power source, localization is achieved at progressively higher tolerances, since alignment between the source and receiver becomes more important.

After the position feature space has been partitioned into a set of S classes, the SVM is trained based on the S classes. Training the SVM corresponds to finding the parameters of the set of hyperplanes that separate each of the S classes. Various widely known algorithms can be used to determine the hyperplanes based on the measured calibration data (e.g., the field amplitude calibration measurements performed by magnetic field detectors 206), using techniques such as the “kernel trick” to ensure that hyperplanes are constructed between fully separated classes of data points. Such algorithms and methods are disclosed, for example, in Duda et al., “Pattern Classification” (John Wiley, 2000), and C. M. Bishop, “Pattern Recognition and Machine Learning” (Springer, 2006), the entire contents of which are incorporated herein by reference.

By measuring calibration data at many positions of the wireless power receiver near the boundaries between classes, the hyperplanes can be determined with very tight margins (e.g., low uncertainty), leading to more robust classification performance. In general, it is the support vectors of the calibration data—the sets of measured magnetic field amplitudes that correspond to relative positions of the wireless power receiver that are closest to the hyperplane boundaries between classes—that define the class boundaries. The support vectors correspond, in effect, to a subset of the most “meaningful” (for classification purposes) raw calibration data.

Determination of the hyperplanes and the support vectors from the raw calibration data can be performed, for example, by processor 108, by processor 116, or by another processor that receives the calibration data and associated class assignments. The support vectors represent a processed form of the raw calibration data. Because the support vectors define the boundaries of the S classes, the support vectors—rather than the entire set of raw calibration data—is stored in an electronic storage unit by the processor that determines the hyperplanes and the support vectors. These support vectors represent the trained SVM classifier that is used to assign the relative position of the wireless power receiver to one of the S classes based on subsequent measurements of amplitudes of measurement magnetic field 212 by the magnetic field detectors 206.

To assign the relative position of the wireless power receiver to one of the S classes when the relative position of the receiver is unknown, field amplitude measurements (i.e., a set of voltages generated by magnetic field detectors 206) is transformed and projected onto the support vectors of the SVM classifier to assign one of the S classes to the relative position of the wireless power receiver.

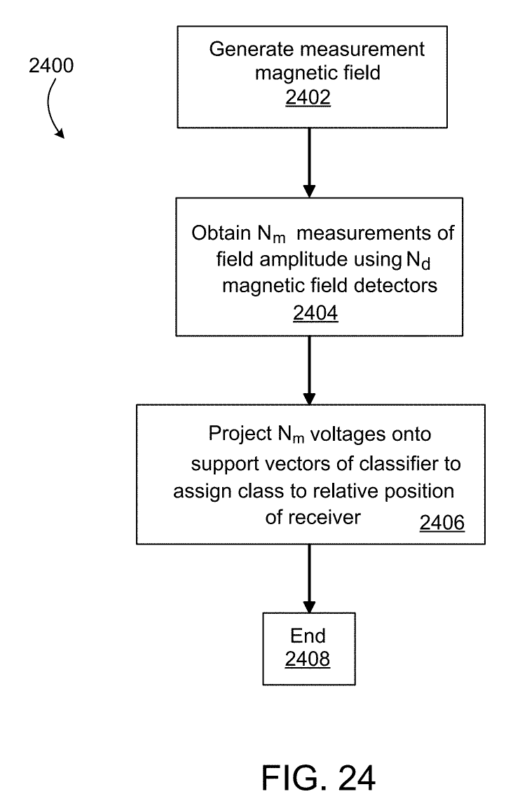

FIG. 24 is a flow chart 2400 that shows a series of steps for assigning one of the S classes to the wireless power receiver. In a first step 2402, with wireless power receiver 204 located at an unknown position relative to wireless power source 202, the processor (i.e., processor 108 and/or processor 116 and/or another system processor) activates a suitable coil, as discussed above, to generate measurement magnetic field 212.

Next, in step 2404, the processor uses the N_{d} magnetic field detectors to obtain Nₘ measurements of the amplitude of the measurement magnetic field 212 in the three spatial coordinate directions, in the manner discussed previously. Note that the measurements correspond to voltages generated by the magnetic field detectors, each of the voltages being related in magnitude to the field amplitude sensed by the magnetic field detectors in corresponding coordinate directions.

Then, in step 2406, the processor transforms and projects the set of Nₘ voltages onto the support vectors of the SVM classifier to determine which of the S classes to assign to the relative position of the wireless power receiver. Methods for performing such a classification are well known and are described, for example, in Duda et al., “Pattern Classification” (John Wiley, 2000), and C. M. Bishop, “Pattern Recognition and Machine Learning” (Springer, 2006).

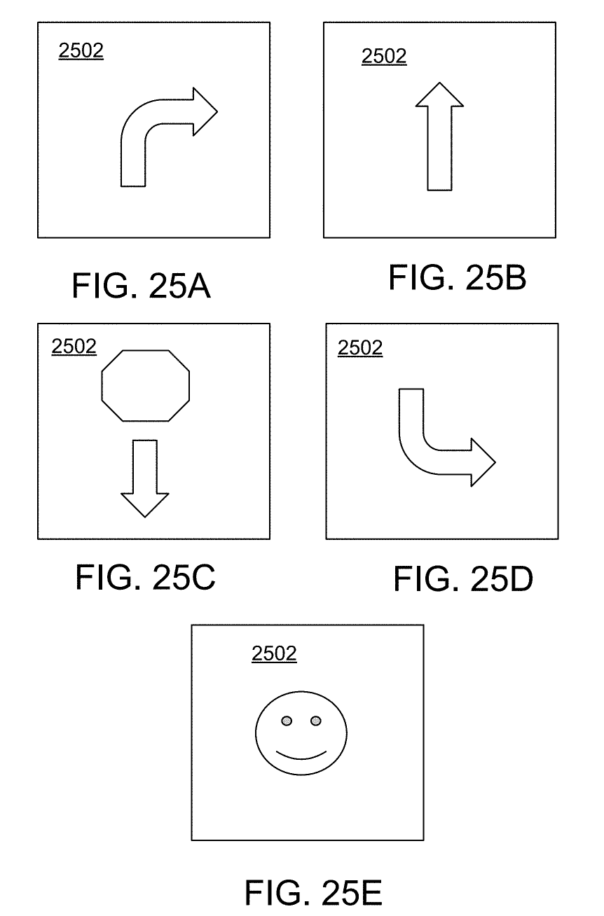

After the relative position of the wireless power receiver has been assigned to one of the S classes, the procedure shown in flow chart 2400 ends at step 2408. Information about the assigned class can be conveyed to the human operator or autonomous driving system of a vehicle in various ways. In some embodiments, where the S classes include a first class representing no power transfer and a second class representing power transfer (see FIG. 16 for example), the processor can indicate to a human operator via a visual signal such as a colored indicator (e.g., red=no power transfer, green=power transfer) which of the classes has been assigned to the relative position of the wireless power receiver. Alternatively, or in addition, the processor can provide an audio signal to the human operator, with different signals representing assignment to each of the two classes. Information about the assigned class can also be provided to an autonomous driving system directly in the form of an electrical signal with the assigned class information encoded therein.

Where the S classes represent guidance feedback corresponding to different vehicle trajectories, the processor can provide a visual representation of the guidance feedback to the human operator via a display unit within the vehicle. FIGS. 25A-25E are schematic diagrams of a display unit 2502 upon which the processor (e.g., processor 108 and/or processor 116 and/or another system or vehicle processor) displays a visual indicator for a human operator corresponding to the guidance feedback class assigned to the relative position of the wireless power receiver. FIG. 25A shows an indicator that provides guidance to continue forward and turn right, FIG. 25B shows an indicator that provides guidance to continue forward in a straight trajectory, FIG. 25C shows an indicator that provides guidance to abort a parking attempt and reverse direction, FIG. 25D shows an indicator that provides guidance to reverse direction and turn right, and FIG. 25E shows an indicator that provides guidance to stop, as the source and receiver are aligned. It should be noted that the visual indicators shown in FIGS. 25A-25E are merely examples, and a wide variety of visual indicators can be provided to achieve similar purposes.

Additionally, or alternatively, the processor can also provide guidance feedback signals to the human operator in the form of audio signals, and in particular, as spoken directions. Such directions are useful, for example, where the human operator is viewing the scene exterior to the vehicle and attention to visual display indicators (e.g., on the vehicle dashboard) is impractical or not possible. Information about the assigned class and corresponding guidance feedback can also be provided to an autonomous driving system directly in the form of an electrical signal with the assigned class information guidance feedback encoded therein.

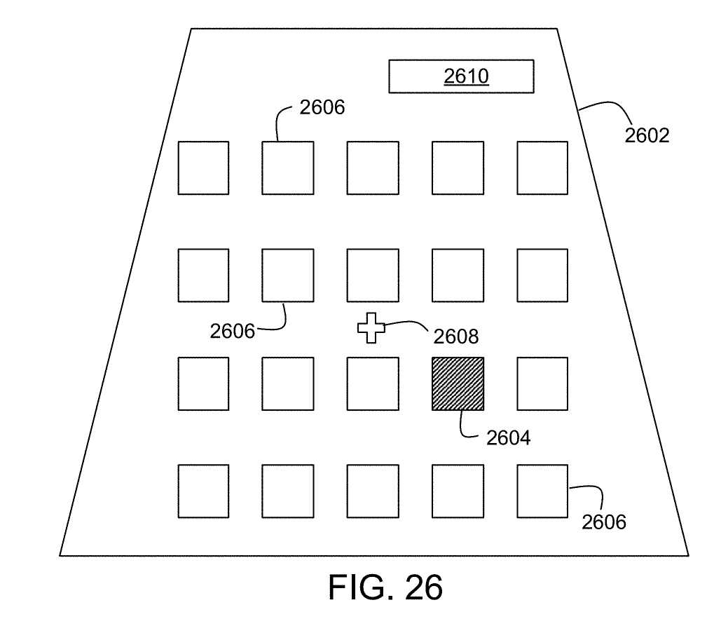

In certain embodiments, where the S classes represent a grid of spatial locations corresponding to the relative position of the wireless power receiver, the processor can provide a visual representation of the relative position of the wireless power receiver within the spatial grid to the human operator via a display unit within the vehicle. FIG. 26 is a schematic diagram showing a display unit 2602 on which the processor displays a visual representation of a set of spatial grid locations 2606. A marker 2608 represents the position of the wireless power source. A corresponding one of the spatial grid locations, 2604, is displayed in contrast (e.g., highlighted and/or displayed in a different color) to provide a visual indication to the human operator of the class assigned to the wireless power receiver and, as a consequently, of the position of the wireless power receiver relative to the wireless power transmitter. In some embodiments, the processor can also display, in block 2610 of display unit 2602 for example, a measurement of the distance between the wireless power receiver and the wireless power source based on the dimensions of the regions corresponding to the S classes. Information about the assigned class and corresponding relative position of the wireless power receiver can also be provided to an autonomous driving system directly in the form of an electrical signal with the assigned class and relative position information encoded therein.

To evaluate the classification performance of the methods disclosed herein, calibration data corresponding to amplitude measurements of measurement magnetic field 212 were obtained for relative positions of wireless power receiver displaced from wireless power source by as much as 1 meter in the x-y plane, and for a variety of different heights (i.e., relative displacements along the z-coordinate direction from the x-y plane, from 90 mm to 150 mm) and yaw angles (from −6 degrees to +6 degrees). Four magnetic field detectors 206 were used to measure magnetic field amplitudes along each of the three orthogonal coordinate directions (x,y,z), yielding a total of 12 voltages at each relative position of wireless power receiver.

In a first example, individual locations in the calibration data were assigned to one of two classes, IN and OUT, according to whether the locations were inside or outside a circle of radius 10 cm. The wireless power source was positioned at the center of the circle. A SVM-based classifier using a nonlinear radius-basis function kernel was used to partition the position feature space into the two classes, and then 4000 different parking events were simulated. Each simulated parking event consisted of positioning the wireless power receiver at a random (x,y,z,θ) position relative to the wireless power source, and using the trained SVM-based classifier to assign the random position associated with the simulated parking event to one of the two classes.

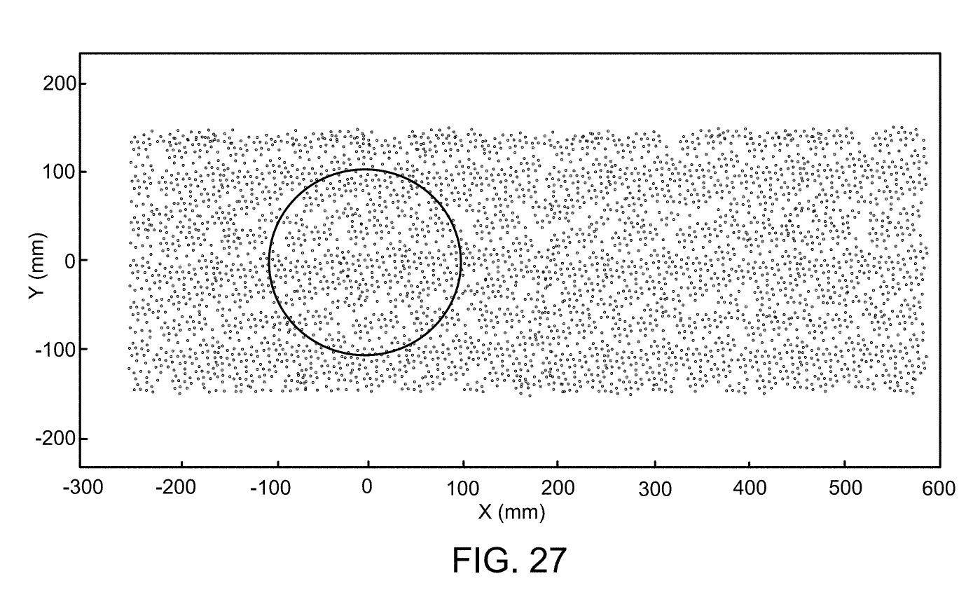

FIG. 27 is a plot showing a set of points, each of which corresponds to one of the simulated parking events (note that points in FIG. 27 are displayed along the x- and y-directions only; z- and θ-coordinates have been collapsed onto the x-y plane). In FIG. 27, darker points correspond to relative positions that the classifier assigned to the OUT class, while lighter points correspond to relative positions that the classifier assigned to the IN class. Among the 499 relative positions that were known to belong to the IN class, 491 (98.4%) were correctly assigned to the IN class by the SVM-based classifier. Among the 3501 relative positions that were known to belong to the OUT class, 3482 (99.45%) were corrected assigned to the OUT class by the SVM-based classifier.

This performance was far superior to the performance of conventional position-determination methods that attempt to determine whether the relative position of the wireless power receiver is within the 10 cm radius circle by calculating the relative position of the wireless power receiver directly from the voltages generated by the magnetic field detectors 206. The largest error occurred for an event in which the wireless power receiver was positioned 6.2 mm outside the circle, but was mistakenly classified as belonging to the IN class. Nonetheless, the magnitude of the error (6.2 mm) was significantly smaller than uncertainties associated with other methods for classification that are based on direct calculation of the relative position of the wireless power receiver based on voltages generated by the magnetic field detectors 206.

Another experiment was performed using the same calibration data partitioned among a different set of classes. Specifically, the calibration data was partitioned among 5 annular regions, defined by circles of radius 80 mm, 100 mm, 125 mm, and 250 mm centered at the position of the wireless power source. Each region extending further outward from the position of the wireless power source represented a region of decreasing power transfer efficiency. A SVM-based classifier was trained based on the partitioned calibration data.

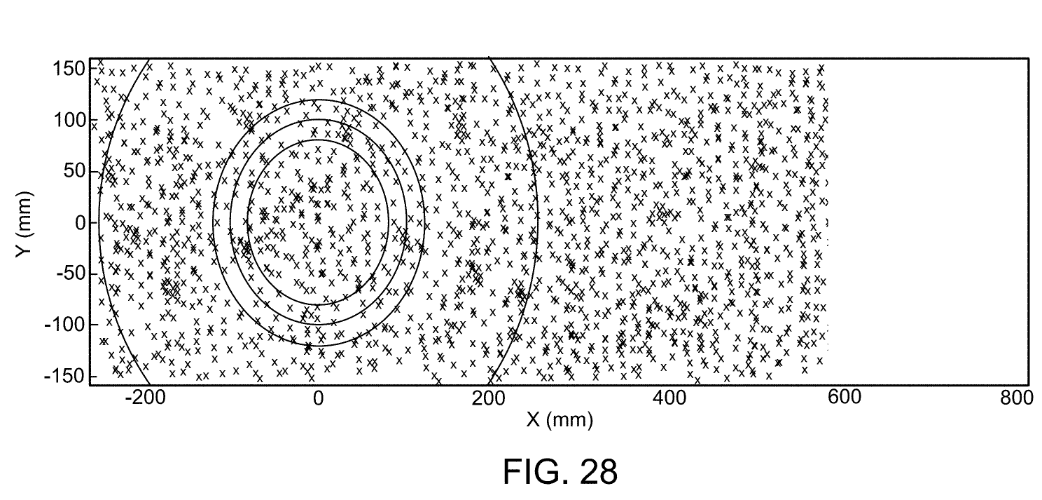

A set of 4000 parking events was simulated by positioning the wireless power receiver at random positions relative to the wireless power source, and the position associated with each event was classified by the SVM-based classifier. FIG. 28 shows a plot of the positions corresponding to the simulated parking events and the boundaries between each of the classes.

A further experiment was performed in which calibration data were obtained and partitioned among 5 classes, each of the classes corresponding to different guidance feedback to an operator of a vehicle. After training an SVM-based classifier based on the partitioned calibration data, a set of 4000 parking events was simulated by positioning the wireless power receiver at random positions relative to the wireless power source, and using the SVM-based classifier to assign the wireless power receiver to one of the 5 classes based on a set of voltages generated by magnetic field detectors 206.

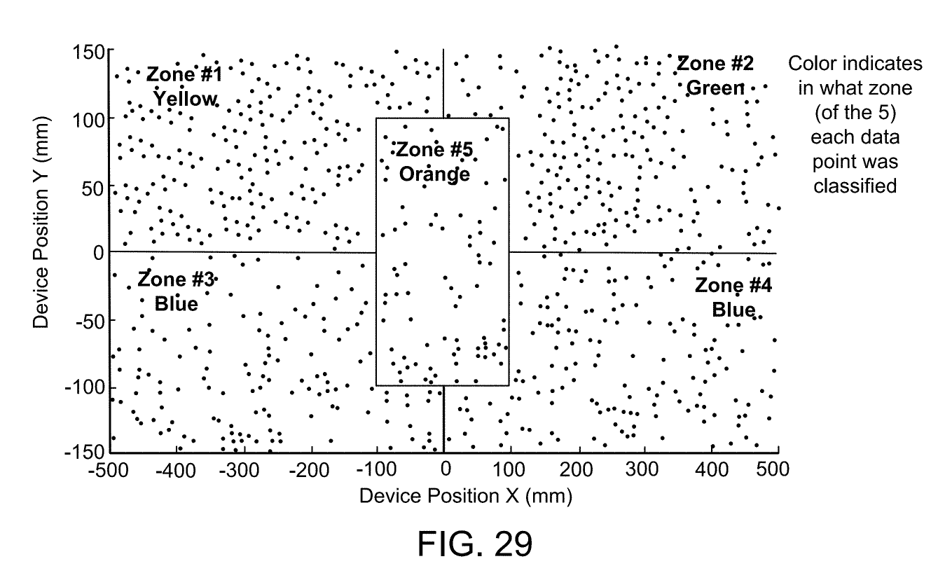

FIG. 29 is a plot showing the positions corresponding to the simulated parking events and the classes into which each of the events was classified. While some of the events were mis-classified, a large majority of the events were properly assigned to one of the 5 classes, demonstrating that meaningful guidance feedback can be provided to a human vehicle operator or autonomous driving system using the methods disclosed herein, without an express calculation of the position of the wireless power receiver relative to the position of the wireless power source.

In another experiment, calibration data were partitioned among a grid of classes, each of dimensions 2 cm×2 cm in the x-y plane, in analogy with FIG. 22. Variations in the z- and θ-coordinates for each data point were collapsed onto the x-y plane. After a SVM-based classifier was trained based on the calibration data, a series of 4000 parking events was simulated in which the relative position of the wireless power receiver on the grid (which was known from the coordinates of the positioning system used to translate the wireless power receiver relative to the wireless power source) was determined for each event by measuring amplitudes of the measurement magnetic field 212 and assigning the wireless power receiver to one of the classes based on voltages generated at the (unknown) relative position of the wireless power receiver by the magnetic field detectors 206. Because the actual relative position of the wireless power receiver for each event was known, the error in position determination for each event could be calculated.

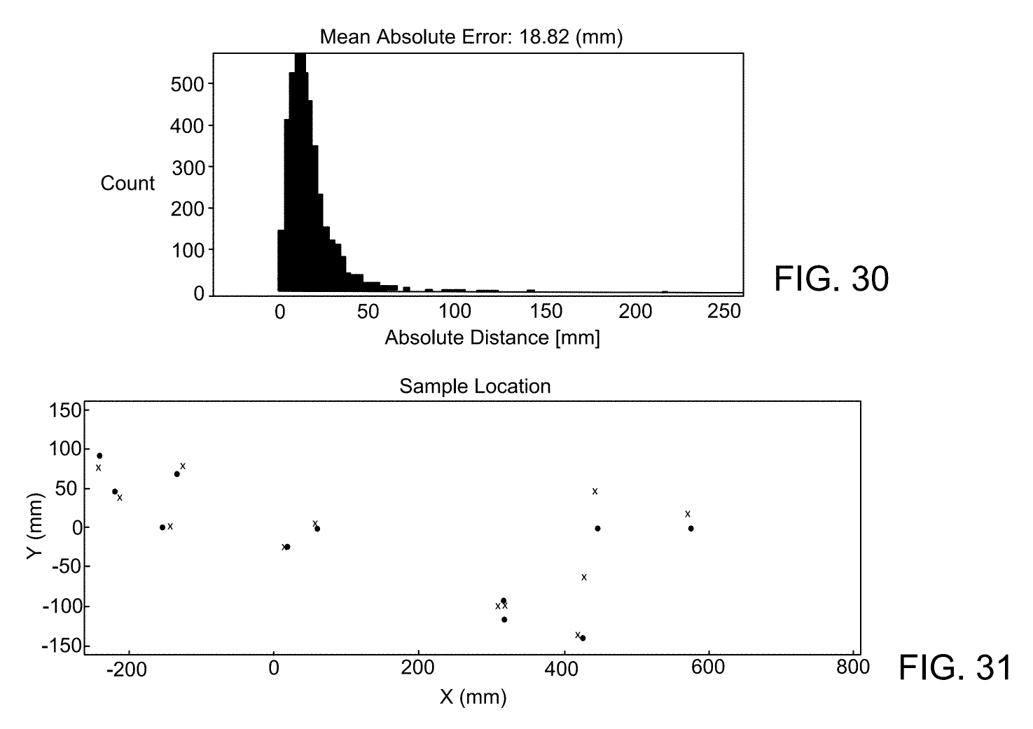

FIG. 30 is a histogram showing the distribution of errors in relative position determination (in distance units from the actual relative position) for each of the simulated events. The mean absolute error was 18.8 mm; 97.9% of the events had an absolute error of less than 50 mm, 80.8% of the events had an absolute error of less than 25 mm, and 24.6% of the events had an absolute error of less than 10 mm. FIG. 31 is a plot showing the actual (crosses) and determined (dots) relative positions of the wireless power receiver for a subset of the events.

The foregoing discussion and experiments demonstrate that SVM-based classification can be used to successfully provide relative position determination, feedback guidance, and power transfer information to a human vehicle operator or autonomous driving system based on amplitude measurements of a measurement magnetic field, without direct computation of the relative position of the wireless power receiver from the field amplitude measurements. A number of advantages can be realized by using a SVM-based classification scheme.

In some embodiments, mis-alignment and mis-operation of magnetic field detectors does not perturb or disrupt the classification procedure, provided the calibration data and field amplitude measurements at the unknown relative position of the wireless power receiver are obtained with the magnetic field detectors in the same condition. If so, anomalies due to mis-alignment and/or mis-operation of the magnetic field detectors are embedded within the calibration data, and therefore do not perturb the assignment of the wireless power receiver into one of the classes.

Further, perturbations to field amplitude measurements arising from variations in vehicle chassis construction, changes in roll, pitch, and/or yaw from events such as vehicle loading and changing tire pressure, and due to metals and ferrous materials nearby such as underground pipes and equipment/fittings near parking spaces, have a relatively small effect on the outcome of the classification due to the relatively smooth nature of the position feature space, and the robust partitioning accomplished by the non-linear hyperplanes separating the classes.

As discussed above, a relatively complex set of field amplitude measurements that are obtained for classification purposes can be reduced to a much simpler set of output classes, with the relative position of the wireless power receiver assigned to one of the set of classes. In this manner, the type of information provided to the vehicle operator can be simplified for easier understanding, and the nature of the information provided (e.g., estimated charging efficiency, guidance feedback) is considerably more sophisticated than simple relative position information.

By using a SVM-based classifier, very strict margins can be enforced on the boundaries of the classes, allowing very accurate assignment of relative positions of the wireless power receiver to one of the classes. This can be achieved even when direct calculation of the relative position of the wireless power source is difficult.

Further, SVM-based classification eliminates direct electromagnetic simulations, and is relatively independent of the shape of measurement magnetic field 212. Instead, asymmetries in the shape of field 212 are encoded directly into the calibration data, and therefore do not perturb the classification procedure.

Calibration data can be measured in a laboratory, and the SVM-based classifier can also be developed in the laboratory. Because the support vectors effectively define the hyperplanes between classes, once the support vectors have been identified, these vectors can be stored and transferred to a processor (e.g., processor 108 and/or 116) for use in classification operations based on measured field amplitudes of measurement magnetic field 212.

For SVM-based classifiers, computational time and memory requirements scale approximately with the number of classes used for partitioning. Thus, for simply binary classifications involving two classes (e.g., IN or OUT), a very small amount of information corresponding to the trained SVM classifier is stored (e.g., the support vectors that define the hyperplane boundary), and classification calculations are performed rapidly.

Further, for purposes of cross-validation and error checking, multiple SVM-based classifiers can be run in parallel for the same set of calibration data. While running multiple classifiers slows down the assignment of the wireless power receiver to a particular one of the classes (due to the additional calculations that are performed), error checking classification assignments using multiple SVM-based classifiers can reduce classification errors significantly.

### Analytical Calibration

In some embodiments, where the shape of measurement magnetic field 212 can be expressed in analytical form as a function of coordinate variables x, y, and z, a processor (e.g., processor 108, processor 116, and/or another system processor) can calculate the amplitudes of magnetic field 212 in each of the three coordinate directions for any relative position of the wireless power receiver. The processor can then convert these calculated field amplitudes into simulated voltages (i.e., voltages that would be generated by magnetic field detectors if exposed to the field amplitudes), based on a scaling relationship between the field amplitude and the voltage magnitude generated by sensors of the field detectors.

To develop a SVM-based classifier, the processor then assigns each of the relative positions to a class, and trains a SVM-based classifier entirely analytically, without making any field amplitude measurements.

Thereafter, to assign a wireless power receiver to one of the classes based on its unknown position, voltage signals corresponding to field amplitudes of the measurement magnetic field 212 are generated by the magnetic field detectors 206 and received by the processor. Based on the voltage signals, the SVM-based classifier assigns the wireless power receiver to one of the classes, as discussed above.

Alternatively, when the shape of measurement magnetic field 212 can be expressed analytically, the processor can construct a look-up table indexed by the relative position of the wireless power receiver, and including expected voltage signals at each relative position, calculated based on the field amplitudes of magnetic field 212 at each relative position and the scaling relationship discussed above. For a set of voltage signals corresponding to an unknown relative position of the wireless power receiver, the processor can then determine the relative position of the wireless power receiver from comparison to look-up table records, as discussed previously.

In some embodiments, where the relative position of the wireless power receiver is determined from a look-up table constructed from the analytical form measurement magnetic field 212, a SVM-based classifier can be trained and used as discussed above to provide a verification of the relative position determination based on the look-up table. The SVM-based classifier can account for a variety of perturbations to measurement magnetic field 212 arising from, for example, foreign objects and debris in the vicinity of wireless power source 202 and/or wireless power receiver 204. The verification provided by the SVM-based classifier can therefore improve the overall accuracy of relative position determination for the wireless power receiver.

### Predictive Trajectory Determination

In some embodiments, the processor (e.g., processor 108, processor 116, or another system processor) is configured to determine an approximate trajectory of the wireless power receiver (based on movement of the vehicle to which the receiver is mounted) based on an accumulated historical set of relative position measurements and/or classification assignments.

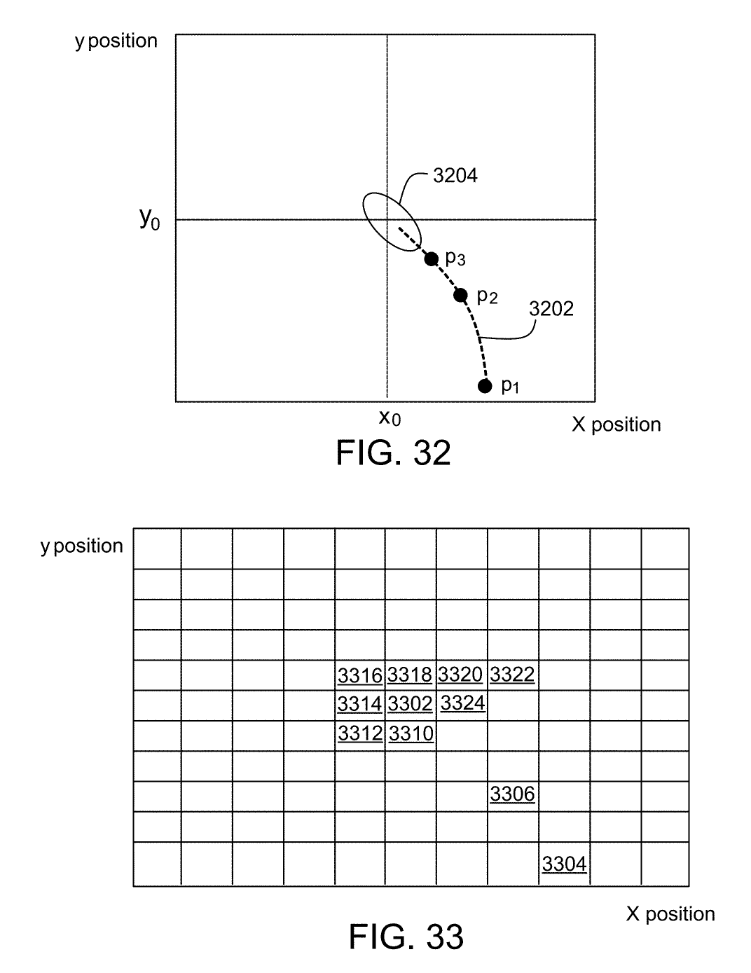

FIG. 32 is a schematic plot showing the x-y relative coordinate plane, with the wireless power source located at (x₀,y₀) in the plane. Points p₁, p₂, and p₃ represent a set of successive relative positions for the wireless power receiver, determined from a look-up table as discussed previously. To determine a predictive trajectory associated with the historical set of measurements p₁-p₃, the processor can fit a functional form (such as a polynomial or power law functional form) to points p₁-p₃, yielding a trajectory curve 3202.

Based on trajectory curve 3203, when the next determination of the relative position of the wireless power receiver is performed, the relative position is expected to fall along or near trajectory curve 3202. The processor can make use of the predicted relative position of the wireless power receiver in various ways.

For example, in certain embodiments, the processor can use information about the predicted relative position of the wireless power receiver to restrict its search through positional data points in the look-up table when the next relative position determination occurs. Rather than searching through all positional data points in the look-up table for potential matches to the set of voltages that are measured by magnetic field detectors 206, the processor can select a subset of the data points in the look-up table that fall within a search region 3204 in proximity to trajectory curve 3202. By restricting similarity calculations to only those positional data points that fall within search region 3204 in the look-up table, the time required to perform similarity calculations and determine the next relative position of the wireless power receiver can be significantly reduced.

Furthermore, by taking into account the historical set of relative position measurements or classifications and the kinematics of the vehicle, the accuracy of present and future classification results can be improved. For example, restricting similarity calculations to only a subset of positional data points implements a filter on possible outcomes of the present classification. This filter effectively reduces effects such as “bouncing” from the classification. In some embodiments, where a feature space vector corresponding to a set of field amplitude measurements lies relatively close to the boundary between two or more classes, the vector can sometimes be classified as belonging to an incorrect class. If the incorrect class corresponds to a relative position of the wireless power receiver that is displaced significantly from its immediate prior location, it can appear as though the vehicle is “bouncing” around in position. Such a result is clearly not physically possible, and can be counteracted by taking into account the physical, kinematic properties of the vehicle.

Specifically, by filtering to allow only a subset of positions or classes as possible outcomes of the classification based on the trajectory of the vehicle, the above “bouncing” can be reduced or eliminated. If the newly determined classification falls outside the allowed range of positions or classes, the processor obtains another set of field amplitude measurements using detectors 206, and then repeats the classification procedure to obtain a new classification result that is more physically appropriate.

In general, a wide variety of different search regions 3204 can be defined by the processor within the look-up table. In some embodiments, for example, search region 3204 has a spherical, ellipsoid, cubic, prismatic, or other regular two-, three-, or four-dimensional shape. In certain embodiments, search region 3204 has an irregular two-, three-, or four-dimensional shape.

In some embodiments, a geometric center of search region 3204 falls along trajectory curve 3202. More generally, however, the geometric center of search region 3204 can be displaced from trajectory curve 3202 by 50% or less (e.g., 40% or less, 30% or less, 20% or less, 10% or less, 5% or less) of a maximum dimension of search region 3204.

In certain embodiments, search region 3204 is selected such that a relatively small subset of positional points within the look-up table fall within search region 3204. The smaller the subset of points within search region 3204, the faster that voltage values corresponding to each point can be compared to voltages generated by magnetic field detectors 206 to determine the relative position of the wireless power receiver. For example, in certain embodiments, 50% or less (e.g., 40% or less, 30% or less, 20% or less, 10% or less, 8% or less, 6% or less, 4% or less, 2% or less) of the total number of positional data points within the look-up table are within search region 3204.

The processor can also use trajectory curve 3202 to provide guidance feedback to the human operator of a vehicle. For example, based on the set of historical relative positions p₁-p₃ of the wireless power receiver, the time intervals between each of the measurements of the relative positions, and trajectory curve 3202, the processor can estimate—for a target point on trajectory curve 3202 that is closest to the position (x₀,y₀) of the wireless power source—the time required to reach the target point from the most recent relative position of the wireless power receiver. The processor can report this estimated time to the vehicle operator on the display unit (e.g., display unit 2502). As successive relative positions of the wireless power receiver are determined, the processor can report updated estimated times to the vehicle operator, in effect implementing a “countdown” to a stopping time for the vehicle.

Similar techniques can be implemented by the processor when the relative position of the wireless power receiver is determined by assigning the receiver to one of a set of classes that form a spatial grid. FIG. 33 is a schematic diagram that shows a set of spatial classes that form a grid. The wireless power source is located in class 3302 at the center of the spatial grid. Historical measurements of the relative position of the wireless power receiver have resulted in the receiver being assigned first to class 3304, then at a later time to class 3306, and then at a still later time to class 3308. As is evident from the spatial locations of these classes, the vehicle to which the wireless power receiver is mounted is following a trajectory similar to trajectory curve 3202 in FIG. 32.

Because the next class to which the wireless power receiver's relative position will be assigned is likely to be in close proximity to class 3302, the processor can increase the speed with which the class assignment is made by projecting the next set of voltages generated by magnetic field detectors 206 and corresponding to the unknown relative position of the wireless power receiver onto only a subset of the support vectors defining the boundaries of a subset of the classes in FIG. 33. By projecting onto only a subset of the support vectors defining “likely” next classes for the relative position of the wireless power receiver, the class assignment involves fewer computations and therefore occurs more rapidly.

As an example, in FIG. 33, the processor can define the subset of “likely” classes as including classes 3310, 3312, 3314, 3316, 3318, 3320, 3322, 3324, and 3302, and can determine the class associated with the unknown relative position of the wireless power receiver by projecting the set of voltage measurements associated with the unknown relative position onto only the support vectors that define the boundaries of classes 3310, 3312, 3314, 3316, 3318, 3320, 3322, 3324, and 3302.

In general, the number of classes within the subset of classes selected by the processor can be significantly less than the total number of classes that form the spatial grid. For example, the selected subset of classes can include 50% or less (e.g., 40% or less, 30% or less, 20% or less, 10% or less, 5% or less, 3% or less) of the total number of classes that form the spatial grid.

Because the relative positions of the wireless power receiver at successive times are effectively determined through class assignments within the spatial grid, the processor can also determine an estimate for the time required by the vehicle to which the wireless power receiver is mounted to reach the position of the wireless power source (i.e., class 3302), using methods analogous to those discussed above in connection with FIG. 32. Further, as discussed above, this time can be reported to the vehicle operator via a display unit, and updated as subsequent relative positions of the wireless power receiver are determined.

### Alignment Detection During Power Transfer

The foregoing systems and methods are generally applied to the determination of the relative position of the wireless power receiver, to assigning classes to the wireless power receiver based on its relative position, and to providing guidance feedback to human vehicle operators and autonomous driving systems prior to the initiation of wireless power transfer from wireless power source 202 to wireless power receiver 204.

However, even after a vehicle is parked—presumably such that wireless power source 202 and wireless power receiver 204 are at least partially aligned—and power transfer has started, it can still be important to verify periodically that the relative position of wireless power receiver 204 has not changed. For example, if a vehicle is involved in a collision while receiving power, or is otherwise displaced inadvertently, power transfer should be halted if wireless power source 302 and wireless power receiver 204 are no longer sufficiently aligned.

To ensure that the relative position of wireless power receiver 204 does not change significantly, power transfer can be halted at intervals (e.g., by processor 108 and/or processor 116), and any of the methods disclosed above can be used to determine the relative position or associated class of wireless power receiver 204. If the relative position or associated class has not changed significantly from the most recent measurement of the relative position or class assignment, then power transfer can be resumed. Alternatively, if the relative position or associated class has changed significantly, the processor (e.g., processor 108, processor 116, or another system processor) can take a variety of different corrective actions including continuing to halt power transfer between wireless power source 202 and wireless power receiver 204.

Alternatively, or in addition, power transfer can be halted based on signals from one or more sensors that may indicate movement of the vehicle to which wireless power receiver 204 is mounted. Referring to FIG. 2, in some embodiments, wireless power transfer system 200 can include one or more sensors 250 that generate signals in response to detected motion, vibration, or loading of wireless power receiver 204 or the vehicle to which wireless power receiver 204 is attached. Sensors 250 can be integrated into wireless power receiver 204 and coupled to processor 116, for example, or be external to wireless power receiver 204 (e.g., attached to the vehicle) and coupled to processor 116 or to another system processor. Combinations of integrated and non-integrated sensors can also be used to detect events separately and/or for mutual verification.

A variety of different sensors can be used. For example, in some embodiments, sensor 250 can be an accelerometer that detects receiver or vehicle motion. In certain embodiments, sensor 250 can be a gyroscope that detects a change in position of the receiver or vehicle.

In some embodiments, sensor 250 can be a capacitance detector that detects changes in the capacitance of the receiver and/or vehicle to distinguish ordinary events (such as a person entering or exiting the vehicle) from non-ordinary events (e.g., a collision).

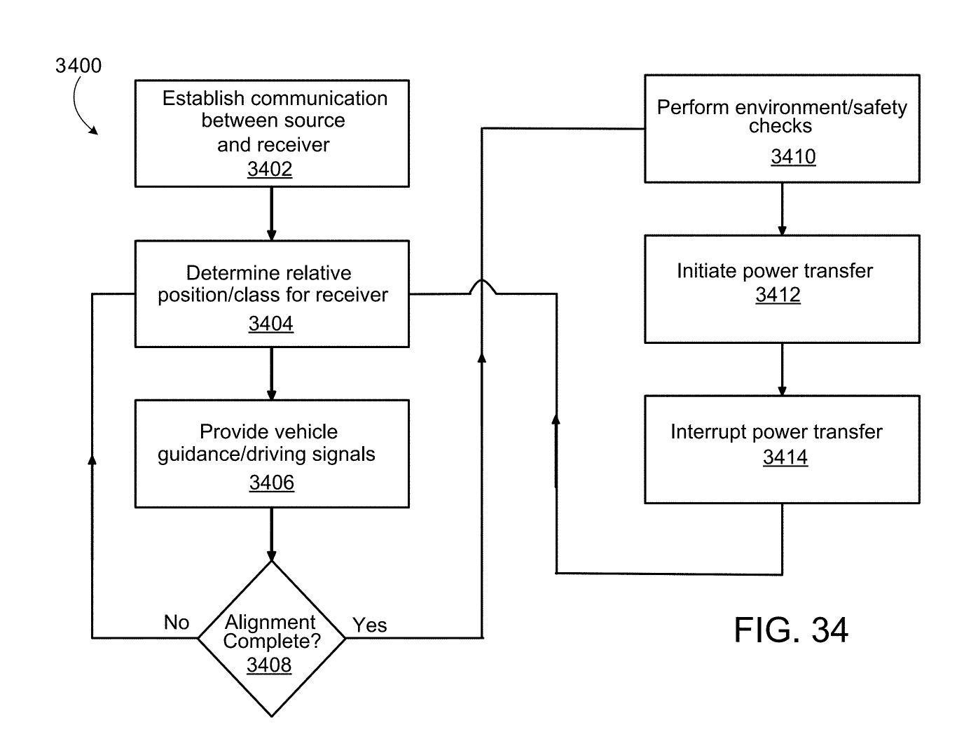

In general, the components and methods disclosed herein can form a portion of a wireless power transfer system that also implements various other performance and safety verifications prior to, and during, wireless power transfer. FIG. 34 is a flow chart 3400 showing one example of a series of steps that can be executed in a wireless power transfer system prior to and during wireless power transfer.

In a first step 3402, a communication link is established between wireless power source 202 and wireless power receiver 204. The link can be established, for example, over a WiFi network or communication protocol, over a Bluetooth® connection, or more generally, over any link, connection, or communication protocol by which the source and receiver communicate.

Next, in step 3404, the system processor (e.g., any of the processors disclosed herein, or another processor that communicates with the processors disclosed herein) determines the relative position of wireless power receiver 204 and/or the class associated with the receiver's relative position, using any of the methods disclosed herein. Then system processor generates a signal that includes information about the receiver's relative position and/or class, and transmits the signal to another processor, controller, or display interface.

In optional step 3406, the system (i.e., the system processor or another processor, circuit, or controller) can provide vehicle guidance information to a vehicle operator or autonomous driving system using the information from the transmitted signal. In some embodiments, this step can include displaying indicators on a vehicle display unit to provide the guidance information.

Next, in step 3408, the system determines whether alignment is complete based on the relative position, or class of the relative position, of the wireless power receiver, i.e., whether the wireless power receiver is within a predetermined distance of the wireless power source, or whether the wireless power receiver is assigned to a particular class. If alignment has not been achieved, control returns to step 3404; if alignment has been achieved, control passes to step 3410.

In step 3410, the system performs additional environmental and safety checks. These can include, for example, checking for foreign objects, checking for living objects, checking for motion of the vehicle/receiver, and monitoring/checking various other safety systems and operating parameters. If all checks and systems are satisfied, then in step 3412, power transfer is initiated from wireless power source 202 to wireless power receiver 204.

After a period of time has elapsed, wireless power transfer can optionally be interrupted at step 3414. A variety of criteria and/or signals can lead to interruption of power transfer. In some embodiments, for example, power transfer can be interrupted periodically to perform additional system checks. In certain embodiments, power transfer can be interrupted when a system sensor (e.g., any of the sensors 250 described above) generates a signal indicating an irregular event, such as an unexpected acceleration of the vehicle/receiver, a change in capacitance of the vehicle/receiver, and/or a change in position of the vehicle receiver. In some embodiments, power transfer can also be interrupted when certain system operating/performance parameters change, such as the voltage and/or current induced in the wireless power receiver.

After power transfer has been interrupted, control returns to step 3404 to perform an alignment check to ensure that the wireless power source and receiver remain aligned. If aligned, and if the environmental and safety checks are passed in step 3410, control eventually returns to step 3412 and power transfer is re-initiated.

### Output Signals and Integration

As discussed above in connection with FIGS. 25A-25E, in some embodiments, the system displays indicators on a display unit (e.g., display unit 150) that is coupled, for example, to processor 116 or another system processor. Display unit 150 can be a component of the vehicle to which the wireless power receiver is mounted (e.g., a dashboard-mounted or—integrated display), or a separate display unit.

In certain embodiments, the wireless power transfer systems disclosed herein generate an output signal that is transmitted by processor 116, processor 108, or by another system processor. As shown in FIG. 1, the output signal can be transmitted to another processor, controller, display interface, or control circuit 160 that is connected to display unit 150. In some embodiments, for example, processor, controller, display interface, or control circuit 160 can be a component of the vehicle to which receiver 204 is mounted.

Processor 160 receives the output signal and uses the information coded therein to perform various functions. In some embodiments, for example, processor 160 can provide driving instructions, position information, and/or directional information to the operator of the vehicle to assist the operator in guiding the vehicle to a position such that source 202 and receiver 204 are aligned. In certain embodiments, processor 160 provides guidance signals to the vehicle's autonomous driving system to guide the vehicle into alignment.

### Hardware and Software Implementation

In general, this disclosure provides examples that include various processors, including processors 108, 116, and 160. It should be understood, however, that all of the measurement, calibration, calculation, classification, and output functions can be performed under the control of any combination of processors 108, 116, 160, and other system processors. In addition, some or all of the functions disclosed herein can be performed by one or more integrated circuits (e.g., application specific integrated circuits (ASICs)), dedicated controllers, and other control/communication devices and circuitry.

The method steps and procedures described herein can generally be implemented in hardware or in software, or in a combination of both. In particular, the processors can include software and/or hardware instructions to perform any of the methods discussed above. The methods can be implemented in computer programs using standard programming techniques following the method steps and figures disclosed herein. Program code is applied to input data (e.g., field measurements, voltage signals) to perform the functions described herein. The output information (e.g., output signals carrying information) can be used to display vehicle position, direction, and guidance information, and to provide driving signals to autonomous vehicle driving systems. Data storage units (e.g., memory units, magnetic storage units and media, optical storage units and media) can be coupled to the processors for information storage and retrieval, including calibration information. The processors and their associated memory can be supplemented by, or incorporated in, ASICs (application specific integrated circuits).

Each program is preferably implemented in a high level procedural or object oriented programming language to communicate with the processor, controller, integrated circuit, or other control device. However, programs can be implemented in assembly or machine language, if desired. In any case, the language can be a compiled or interpreted language. Each computer program can be stored on a storage medium or device (e.g., a volatile memory unit and/or non-volatile memory unit) readable by the processors, integrated circuits, controllers, and control devices, for configuring and operating the processors, integrated circuits, controllers, and control devices to perform the procedures described herein.

### Other Embodiments

A number of embodiments have been described. Nevertheless, it will be understood that various modifications may be made without departing from the spirit and scope of the disclosure. Accordingly, other embodiments are within the scope of the following claims.

What is claimed is:

1. A method, comprising:
generating a set of Nₘ voltage values using one or more magnetic field detectors, wherein each voltage value is related in magnitude to an amplitude of a magnetic field between a wireless power source and a wireless power receiver mounted to a vehicle;
classifying the set of Nₘ voltage values into one of two classes, wherein each of the two classes represents a different spatial region defining a range of positions of the wireless power receiver relative to a position of the wireless power source; and
transmitting a signal comprising output information to a processor or display interface, the output information comprising information about the one class into which the set of voltage values was classified,
wherein the two classes comprise:
a first class associated with a range of relative positions of the wireless power receiver that are within a charging zone of the wireless power source; and
a second class associated with a range of relative positions of the wireless power receiver that are outside the charging zone of the wireless power source.

2. The method of claim 1, further comprising displaying on a display unit an indicator associated with the one class based on the signal, to provide power transfer information to a vehicle operator or autonomous driving system.

3. The method of claim 1, wherein the set of Nₘ voltage values corresponds to measurements of the amplitude of the magnetic field in three different directions.

4. The method of claim 1, wherein the set of Nₘ voltage values corresponds to measurements of the amplitude of the magnetic field in one direction.

5. The method of claim 1, wherein a frequency of the magnetic field is different from a frequency of a power transfer magnetic field that the wireless power source is configured to generate to transfer power from the wireless power source to the wireless power receiver.

6. The method of claim 1, wherein the first class represents a spatial region having a rotationally symmetric shape in a plane parallel to a plane defined by a resonator coil of a source resonator of the wireless power source.

7. The method of claim 1, further comprising:
classifying the set of Nₘ voltage values using a support vector machine-based classifier; and
training the support vector machine-based classifier by:
for each one of a plurality of Nₚ positions of the wireless power receiver relative to the wireless power source, generating a set of Nₘ voltage values using the one or more magnetic field detectors, wherein each voltage value is related in magnitude to an amplitude of a magnetic field between the wireless power source and the wireless power receiver;
assigning the set of Nₘ voltage values at each of the Nₚ positions to one of the two classes; and
determining a boundary between the two classes and a set of support vectors associated with the boundary.

8. The method of claim 1, further comprising generating the magnetic field between the wireless power source and the wireless power receiver using a source resonator of the wireless power source, wherein each one of the one or more magnetic field detectors is coupled to the wireless power receiver.

9. The method of claim 1, wherein the wireless power source comprises a source resonator, the method further comprising generating the magnetic field between the wireless power source and the wireless power receiver using a secondary coil of the wireless power source, wherein each one of the one or more magnetic field detectors is coupled to the wireless power receiver.

10. The method of claim 1, wherein the wireless power receiver comprises a receiver resonator, the method further comprising generating the magnetic field between the wireless power source and the wireless power receiver using a secondary coil of the wireless power receiver, wherein each one of the one or more magnetic field detectors is coupled to the wireless power source.

11. The method of claim 1, wherein the wireless power receiver comprises a receiver resonator comprising a resonator coil, the method further comprising generating at least some of the set of Nₘ voltage values using the resonator coil of the receiver resonator.

12. A wireless power transfer system, comprising:
a wireless power source comprising a source resonator;
a wireless power receiver configured to be mounted to a vehicle and comprising a receiver resonator configured to couple to a power transfer magnetic field generated by the wireless power source to transfer power to the wireless power receiver;
one or more magnetic field detectors; and
one or more processors in communication with the wireless power source, the wireless power receiver, and the one or more magnetic field detectors,
wherein during operation of the system:
the one or more magnetic field detectors are configured to generate a set of Nₘ voltage values, wherein each voltage value is related in magnitude to an amplitude of a measurement magnetic field between the wireless power source and the wireless power receiver;
at least one of the one or more processors is configured to classify the set of Nₘ voltage values into one of two classes, wherein each of the two classes represents a different spatial region defining a range of positions of the wireless power receiver relative to a position of the wireless power source; and
at least one of the one or more processors is configured to transmit a signal comprising output information to a vehicle processor or display interface, the output information comprising information about the one class into which the set of voltage values was classified; and
wherein the multiple classes comprise:
a first class associated with a range of relative positions of the wireless power receiver that are within a charging zone of the wireless power source; and
a second class associated with a range of relative positions of the wireless power receiver that are outside the charging zone of the wireless power source.

13. The wireless power transfer system of claim 12, further comprising a display unit in communication with the one or more processors, wherein during operation of the system, the display unit is configured to display an indicator associated with the one class to provide power transfer information to a vehicle operator or autonomous driving system.

14. A method, comprising:
generating a set of Nₘ voltage values using one or more magnetic field detectors, wherein each voltage value is related in magnitude to an amplitude of a magnetic field between a wireless power source and a wireless power receiver mounted to a vehicle;
classifying the set of Nₘ voltage values into one of multiple classes, wherein each of the multiple classes represents a different spatial region defining a range of positions of the wireless power receiver relative to a position of the wireless power source; and
transmitting a signal comprising output information to a processor or display interface, the output information comprising information about the one class into which the set of voltage values was classified,
wherein the multiple classes are associated with different trajectories of the vehicle; and
wherein the multiple classes comprise:
a first class associated with a trajectory corresponding to forward motion of the vehicle in a straight line;
a second class associated with a trajectory corresponding to a combination of forward motion and a right turn of the vehicle;
a third class associated with a trajectory corresponding to a combination of forward motion and a left turn of the vehicle; and
a fourth class associated with a trajectory corresponding to stopping the vehicle.

15. The method of claim 14, further comprising displaying on a display unit an indicator associated with the one class based on the signal, to provide at least one of vehicle position information and vehicle direction information to a vehicle operator or autonomous driving system.

16. The method of claim 14, wherein the set of Nₘ voltage values corresponds to measurements of the amplitude of the magnetic field in three different directions.

17. The method of claim 14, wherein the set of Nₘ voltage values corresponds to measurements of the amplitude of the magnetic field in one direction.

18. The method of claim 14, wherein the multiple classes further comprise:
a fifth class associated with a trajectory corresponding to backward motion of the vehicle in a straight line;
a sixth class associated with a trajectory corresponding to a combination of backward motion of the vehicle and a right turn of the vehicle; and
a seventh class associated with a trajectory corresponding to a combination of backward motion of the vehicle and a left turn of the vehicle.

19. The method of claim 14, wherein each of the second and third classes represents a different spatial region having a polygonal shape, and wherein at least two sides of each different spatial region are curved in a plane parallel to a plane defined by a resonator coil of a source resonator of the wireless power source.

20. The method of claim 14, further comprising:
classifying the set of Nₘ voltage values using a support vector machine-based classifier; and
training the support vector machine-based classifier by:
for each one of a plurality of Nₚ positions of the wireless power receiver relative to the wireless power source, generating a set of Nₘ voltage values using the one or more magnetic field detectors, wherein each voltage value is related in magnitude to an amplitude of a magnetic field between the wireless power source and the wireless power receiver;
assigning the set of Nₘ voltage values at each of the Nₚ positions to one of the multiple classes; and
determining a set of boundaries between the multiple classes and a set of support vectors associated with the set of boundaries.
